(19) United States
(12) Patent Application Publication
(10) Pub. No.: US 2007/0166059 A1
(43) Pub. Date: Jul. 19, 2007

(54) Image forming apparatus, toner counter and method of calculating toner consumption amount

(75) Inventors: Hidenori Kin, Nagano-ken (JP); Toshiki Shiroki, Nagano-ken (JP); Isao Inaba, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO CORPORATION, TOKYO (JP)

(21) Appl. No.: 10/597,810

(22) PCT Filed: Sep. 28, 2005
(86) PCT No.: PCT/JP05/17846

§ 371 Date: Aug. 8, 2006

(30) Foreign Application Priority Data
Sep. 30, 2004 (JP) 2004-287299
Sep. 30, 2004 (JP) 2004-287300
Sep. 12, 2005 (JP) 2004-263543
Sep. 12, 2005 (JP) 2005-263544
Sep. 12, 2005 (JP) 2005-263545

(51) Int. Cl. G03G 15/08

(52) U.S. Cl. 399/27

(57) ABSTRACT

The toner consumption amount in the image forming apparatus is calculated accurately. The printing dot subject to process (mark of a circle with hatching) is divided into classes depending upon the number of adjacent dot (mark of a white circle) present around the dot subject to process, and the number of dots is counted for each of the classes. The toner adhesion amount of the printing dot is different depending upon the number of the adjacent dots, hence weight coefficients K0 through K8 corresponding to the difference are set in advance. The count for each of the classes is multiplied by the coefficient corresponding to each of the classes and accumulated, whereby the toner consumption amount is calculated accurately in a state that dots are arranged in two dimension.

### TECHNICAL FIELD

The present invention relates to a technique for calculating an amount of toner consumed in forming a toner image in an image forming apparatus which forms a toner image with toner.

### BACKGROUND ART

It is necessary for an electrophotographic image forming apparatus, such as a printer, a copier machine and a facsimile machine, which forms an image with toner to grasp a toner consumption amount or a remaining toner amount for the purpose of maintenance such as replenishment of toner Noting this, techniques for accurately calculating a toner consumption amount (hereinafter referred to as “toner count techniques”) have been proposed. For instance, according to the toner consumption detecting method described in Patent Document 1, strings of printing dots are classified into plural patterns in accordance with the state of continuity of the dots and their numbers of occurrence are counted individually. The counts are multiplied by predetermined coefficients respectively and then added together, whereby the total toner consumption amount is calculated. In this manner, the toner consumption amount is calculated at a high accuracy regardless of the non-linearity between the number of printing dots and an adhering toner amount which is attributable to a difference in the state of continuity of the printing dots.

Patent Document 1: Japanese Patent Application Laid-Open Gazette No. 2002-174929

### DISCLOSURE OF THE INVENTION

Problems to be Solved by the Invention

In an actual image forming operation, a lot of the strings of printing dots mentioned-above are formed and arranged in two dimensions, whereby two-dimensional image is obtained. However, in the conventional toner count technique described above, since only the continuity of the dots in one direction (in a direction of the string) in the two-dimensional image is considered, there is a room for improvement in a degree of accuracy.

Further, a state of two-dimensional arrangement of printing dots is not in complete random, there are some cases that the state has a certain regularity depending upon the content of formed images. For example, printing dots of halftone are frequently used in photographic images, whereas printing dots of halftone do not appear often and each of the printing dots is often expressed in binary data of complete on or complete off in images based on a character. Further, in the case where signal processing including screen processing is executed to given image signal, there may appear a regularity in a state of arrangement of dots which corresponds to a pitch and the like of the screen used. It is expected to promote efficiency of toner count technique by utilizing this regularity, but it has not been taken into consideration about this point in the conventional technique described above.

Means for Solving the Problems

The invention has been made in light of the problem described above, and has an object to provide a technique which is able to obtain a toner consumption amount in an image forming apparatus efficiently and accurately.

In addition, in the present description, each of dots to which toner should adhere and each of dots to which toner should not adhere are referred to as “a printing dot” and “an off dot”, respectively. In the case where merely referred to as “a dot”, it will not be particularly distinguished between the printing dot and the off dot.

A first aspect of an image forming apparatus, a toner counter, and a method of calculating toner consumption amount according to the invention, in order to accomplish the object described above, in an image forming apparatus which visualizes an electrostatic latent image on a surface of a latent image carrier with toner and forms a toner image, is characterized in that a toner consumption amount is calculated based on a state of a two-dimensional arrangement of printing dots formed on the latent image carrier.

Since the electrostatic latent image on the latent image carrier spreads in two dimensions, a toner adhesion amount is different depending upon a state of the arrangement of the printing dots not only in one direction but also in other directions. Hence, the toner amount consumed in forming a dot, even if it is a single printing dot, is different depending upon the state of arrangement of the printing dots around it. The difference of the toner adhesion amount depending upon the state of arrangement of the printing dots is attributed to the fact that the latent images corresponding to the respective printing dots which are at adjacent positions interfere mutually, and a phenomenon (edge effect) in which a toner density is high at an edge portion than at a central portion of the printing dot. Consequently, the toner consumption amount is calculated based on the state of the two-dimensional arrangement of the printing dots according to the invention. In this way, it is possible to calculate the toner consumption amount more accurately than the conventional toner count technique which takes into consideration only the state of the arrangement in one direction.

The invention is preferably applicable especially to an image forming apparatus structured to form a two-dimensional electrostatic latent image in such a way that the surface of the photosensitive member (latent image carrier) charged at a predetermined surface potential is scanned and exposed with a laser light or exposed with an emission of light from LED array to form a linear latent image while the light source and the photosensitive member are relatively moved.

Further, the inventors executed an experiment to form images of various patterns in which the sizes of the printing dots are constant and only the intervals between the adjacent printing dots are varied, and to measure a toner consumption amount of each of the images. In a result, it became clear that the toner consumption amount of each of the printing dots varies intricately depending upon the change of the interval between the printing dots. The mode of the change of the toner consumption amount will be described in detail hereinafter. This is attributed to the fact that a certain amount of toner adheres to an area which is not planned to adhere toner originally, that is, off dot, which is formed between the printing dots, and that the adhesion amount varies depending upon the successive state of the off dots. And it became known, based on the result of the experiment, that not only the number of the printing dots or the successive state thereof but also the state of the distribution of the printing dots are taken into consideration, whereby the toner consumption amount is calculated accurately.

Consequently, a second aspect of an image forming apparatus, a toner counter, and a toner consumption amount calculator according to the invention, in order to accomplish the object described above, calculates a toner consumption amount consumed in forming a toner image by visualizing an electrostatic latent image with toner, and varies a mode of the calculation of the toner consumption amount depending upon a distribution state of printing dots to which toner should adhere in the toner image. According to the invention structured in this way, it is possible to adopt the calculation mode in accordance with the distribution state of the printing dots, whereby the toner consumption amount is calculated accurately.

Further, a third aspect of an image forming apparatus, a toner counter, and a toner consumption amount calculator according to the invention, in an image forming apparatus which executes a predetermined signal processing to an image signal and generates a printing-dot data regarding an arrangement of printing dots, forms an electrostatic latent image on a latent image carrier corresponding to the printing dots, and visualizes the electrostatic latent image with toner, thereby forming a toner image which corresponds to the image signal, is characterized in that a toner amount consumed in forming the toner image based on a state of a two-dimensional arrangement of the printing dots in the electrostatic latent image is calculated, and a mode of a calculation of the consumed toner amount depending upon a content of the printing-dot data is varied.

According to this invention, the toner consumption amount is calculated based on the two-dimensional arrangement of the printing dots, whereby the toner consumption amount is calculated in high accuracy. Further, the mode of the calculation is not uniform but varied depending upon the content of the printing-dot data, whereby the toner consumption amount is obtained more efficiently than by the conventional technique in which the mode of the calculation is uniform.

Further, a fourth aspect of an image forming apparatus, a toner counter, and a toner consumption amount calculator according to the invention, in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, in order to accomplish the object described above, is characterized in that the toner image is divided into a plurality of unit segments having a predetermined size, a toner consumption amount of each of the plurality of unit segments is calculated based on the printing-dot data, each of the toner consumption amounts is accumulated, whereby a toner consumption amount of the entire toner image is calculated, and the settings of the size of the unit segment is varied depending upon a content of the printing-dot data.

According to this invention, the toner image is divided into a plurality of unit segments of which the size is set depending upon the content of the printing-dot data, and the toner consumption amount is calculated for each unit segment. In this way, the calculation unit of the toner consumption amount is not uniform but set depending upon a content of the printing-dot data, whereby the regularity which appears in the printing-dot data is utilized effectively, and the toner consumption amount is obtained efficiently.

Furthermore, the inventors compared and verified three techniques by the experiments using various kinds of images as samples, the three techniques being the technique (this technique is called “simple counting technique” hereinafter) to calculate the toner consumption amount of each of the printing dots individually without considering the continuity of dots, the technique (this technique is called “one-dimensional counting technique” hereinafter) to calculate the toner consumption amount considering the continuity of dots in one dimension as in the conventional technique described above, and the technique (this technique is called “two-dimensional counting technique” hereinafter) to calculate the toner consumption amount considering the state of the two-dimensional arrangement of the printing dots. It turned out that, in terms of the accuracy of calculation of the toner consumption amount, the two-dimensional counting technique was the best regardless of the content of the formed image, which is followed by the one-dimensional counting technique and the simple counting technique in this order. However, it became clear that, in some cases, there is little difference among the three technique depending upon the content of the formed image. On the other hand, in terms of the simplicity of the process, the simple counting technique is the simplest and the process becomes more complex and the process time becomes longer in the order of the one-dimensional counting technique and the two-dimensional counting technique.

It became clear that the simple counting technique and the two-dimensional counting technique are selectively used depending upon the content of the image, whereby the efficiency of the calculation process is enhanced while maintaining the high accuracy of calculation.

Based on this knowledge, a fifth aspect of an image forming apparatus, a toner counter, and a toner consumption amount calculator according to the invention, in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, in order to accomplish the object described above, is characterized in that, either one of a simple count mode and a two-dimensional count mode is selected based on the content of the printing-dot data, and the toner amount consumed in forming the toner image is calculated in the selected mode, the simple count mode calculating a toner consumption amount of each of the printing dots based on the printing-dot data corresponding to the printing dot subject to calculation, the two-dimensional count mode calculating a toner consumption amount of each of the printing dots based on a state of a two-dimensional arrangement of the printing dots on the latent image carrier.

According to this invention, it is possible to select properly to use the simple count mode and the two-dimensional count mode, whereby the toner consumption amount in the image forming apparatus is calculated efficiently and accurately.

Effects of the Invention

According to these inventions, it is possible to calculate the toner amount consumed in forming the toner image in the image forming apparatus efficiently and accurately.

### BRIEF DESCRIPTION OF THE DRAWINGS

FIG. 1 is a drawing which shows an example of the structure of an image forming apparatus to which the invention is favorably applicable.

FIG. 2 is a block diagram of the electric structure of the image forming apparatus shown in FIG. 1.

FIG. 3 is a diagram which shows signal processing blocks of the apparatus.

FIG. 4 is a diagram which shows a first embodiment of a toner counter according to the invention.

FIG. 5 is a drawing which shows an example of data of a video signal.

FIG. 6 is a schematic diagram which shows a content stored in the data buffer.

FIG. 7 is a diagram showing a structure of the toner counter of the first embodiment.

FIG. 8 is a diagram showing classes of the printing dots based on the number of an adjacent dot.

FIG. 9 is a diagram showing an actual example of an arrangement of the printing dots and the toner count.

FIG. 10 is a graph showing a matching of the calculated value and the measured value of the toner consumption amount.

FIG. 11 is a group of drawings which show examples of screens used in the half-toning processing.

FIG. 12 is a diagram which shows a second embodiment of a toner counter according to the invention.

FIG. 13 is a group of drawings which show examples of test patterns used in the experiments.

FIG. 14 is a graph showing the relationship between the line interval and the toner consumption amount.

FIG. 15 is a drawing which shows the relationship between the dot count value and the toner consumption amount.

FIG. 16 is a diagram which shows a structure of the toner counter in the second embodiment.

FIG. 17 is a drawing which shows an example of an image in which text and graphic are mixed.

FIG. 18 is a drawing which shows an example of a state of arrangement of the printing dots on the photosensitive member.

FIG. 19 is a drawing which shows a first table which corresponds to a (3 by 3) matrix.

FIG. 20 is a drawing which shows a second table which corresponds to a (3 by 5) matrix.

FIG. 21 is a drawing which shows a mode of selection of the matrixes and the tables.

FIG. 22 is a group of drawings for describing the difference of the applied screen for each toner color.

FIG. 23 is a diagram which shows a structure of a toner counter of a third embodiment.

FIG. 24 is a group of drawings which show a relationship between the image content and the frequency of appearance of the printing dot having the various tone level.

FIG. 25 is a group of drawings which show examples of the setting of the unit segment.

FIG. 26 is a group of drawings which show examples of the arrangement pattern of the printing dots after the screen processing is executed.

FIG. 27 is a diagram which shows a structure of a toner counter in a fourth embodiment.

FIG. 28 is a graph showing the relationship between the number of the adjacent dots and the toner adhesion amount.

FIG. 29 is a drawing which shows an example of the conversion table from the number of the adjacent dots to the toner consumption amount.

FIG. 30 is a drawing which shows a conversion table from the dot pattern to the toner adhesion amount.

FIG. 31 is a diagram which shows a structure of a toner counter of the fifth embodiment.

FIG. 32 is a diagram which shows a structure of a toner counter of the sixth embodiment.

### DESCRIPTION OF REFERENCE CHARACTERS

4: developer unit (developing section)

6: exposure unit (latent image forming section)

11: main controller (signal processor)

22: photosensitive member (latent image carrier)

120, 130, 140, 150, 160: data buffer (storage)

200, 220, 230, 240, 250, 260: toner counter (toner consumption amount calculator, toner counter)

EG: engine part (image forming section)

### BEST MODES FOR CARRYING OUT THE INVENTION

<Structure of Apparatus>

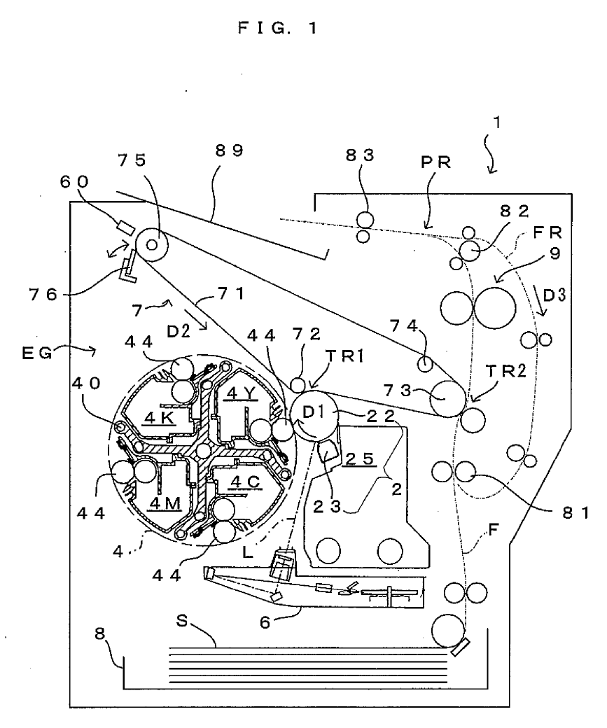

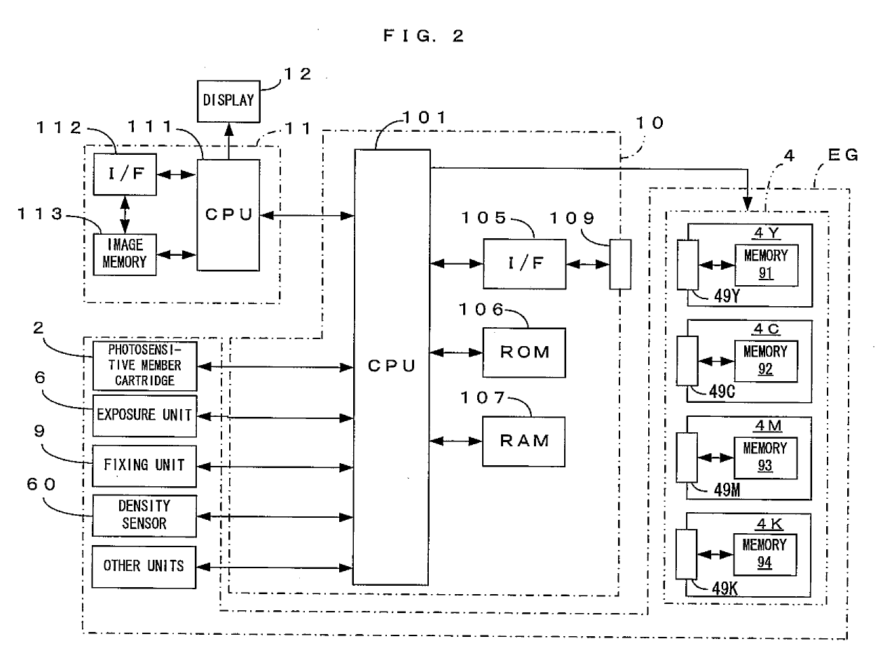

FIG. 1 is a drawing which shows an example of the structure of an image forming apparatus to which the invention is favorably applicable. FIG. 2 is a block diagram of the electric structure of the image forming apparatus shown in FIG. 1. The illustrated apparatus 1 is an image forming apparatus which overlays toner (developer) in four colors of yellow (Y), cyan (C), magenta (M) and black (K) one atop the other and accordingly forms a full-color image, or forms a monochrome image using only black toner (K). In the image forming apparatus 1, when an image signal is fed to a main controller 11 from an external apparatus such as a host computer, an engine controller 10 controls respective portions of an engine part EG in accordance with an instruction received from the main controller 11 to perform a predetermined image forming operation and forms an image which corresponds to the image signal on a sheet S.

In the engine part EG, a photosensitive member 22 is disposed so that the photosensitive member 22 can freely rotate in the arrow direction D1 shown in FIG. 1. Around the photosensitive member 22, a charger unit 23, a rotary developer unit 4 and a cleaner 25 are disposed in the rotation direction D1. A predetermined charging bias is applied upon the charger unit 23, whereby an outer circumferential surface of the photosensitive member 22 is charged uniformly to a predetermined surface potential. The cleaner 25 removes toner which remains adhering to the surface of the photosensitive member 22 after primary transfer, and collects the toner into a used toner tank which is disposed inside the cleaner 25. The photosensitive member 22, the charger unit 23 and the cleaner 25, integrated as one, form a photosensitive member cartridge 2. The photosensitive member cartridge 2 can be freely attached to and detached from a main body of the apparatus 1 as one integrated unit.

An exposure unit 6 emits a light beam L toward the outer circumferential surface of the photosensitive member 22 which is thus charged by the charger unit 23. The exposure unit 6 makes the light beam L expose on the photosensitive member 22 in accordance with the image signal fed from the external apparatus and forms an electrostatic latent image which corresponds to the image signal.

The developer unit 4 develops thus formed electrostatic latent image with toner. That is, in this embodiment, the developer unit 4 comprises a support frame 40 which is disposed for free rotations about a rotation shaft which is perpendicular to the plane of FIG. 1, and also comprises a yellow developer 4Y, a cyan developer 4C, a magenta developer 4M and a black developer 4K which house toner of the respective colors and are formed as cartridges which are freely attachable to and detachable from the support frame 40. The engine controller 10 controls the developer unit 4. The developer unit 4 is driven into rotations based on a control instruction from the engine controller 10, and when the developers 4Y, 4C, 4M and 4K are selectively positioned at a predetermined developing position which faces the photosensitive member 22 with a predetermined gap in-between, toner is supplied onto the surface of the photosensitive member 22 from a developer roller 44 disposed to the selected developer, the developer roller 44 being disposed in the developer there-positioned, carrying charged toner of a selected color, and being applied with a predetermined developing bias. As a result, the electrostatic latent image on the photosensitive member 22 is visualized in the selected toner color.

Non-volatile memories 91 through 94 which store information regarding the respective developers are disposed to the developers 4Y, 4C, 4M and 4K. One of connectors 49Y, 49C, 49M and 49K disposed to the respective developers selected as needed and a connector 109 which is disposed to the main body are connected with each other, and a CPU 101 of the engine controller 10 and one of the memories 91 through 94 communicate with each other. In this manner, the information regarding the respective developers is transmitted to the CPU 101 and the information inside the respective memories 91 through 94 is updated and stored. In addition, the communication between the CPU 101 and each of the memories 91 through 94 is not limited to perform through a mechanical contact such as connectors described above. It may be performed by means of a non-contact communicating device such as a wireless communication.

A toner image developed by the developer unit 4 in the manner above is primarily transferred onto an intermediate transfer belt 71 of a transfer unit 7 in a primary transfer region TR1. The transfer unit 7 comprises the intermediate transfer belt 71 which runs across a plurality of rollers 72 through 75, and a driver (not shown) which drives a roller 73 into rotations to thereby rotate the intermediate transfer belt 71 in a predetermined rotation direction D2. For transfer of a color image on the sheet S, toner images in the respective colors formed on the photosensitive member 22 are superposed one atop the other on the intermediate transfer belt 71, thereby forming a color image, and the color image is secondarily transferred onto the sheet S which is unloaded from a cassette 8 one at a time and transported to a secondary transfer region TR2 along a transportation path F.

At this stage, for the purpose of correctly transferring the image held by the intermediate transfer belt 71 onto the sheet S at a predetermined position, the timing of feeding the sheet S into the secondary transfer region TR2 is managed. To be more specific, there is a gate roller 81 disposed in front of the secondary transfer region TR2 on the transportation path F. As the gate roller 81 rotates in synchronization to the timing of rotations of the intermediate transfer belt 71, the sheet S is fed into the secondary transfer region TR2 at predetermined timing.

Further, the sheet S now bearing the color image is transported to a discharge tray 89, which is disposed to a top surface of the main body of the apparatus, through a fixing unit 9, a pre-discharge roller 82 and a discharge roller 83. Meanwhile, when images are to be formed on the both surfaces of the sheet S, the discharge roller 83 starts rotating in the reverse direction upon arrival of the rear end of the sheet S, which carries the image on its one surface as described above, at a reversing position PR located behind the pre-discharge roller 82, thereby transporting the sheet S in the arrow direction D3 along a reverse transportation path FR. While the sheet S is returned back to the transportation path F again before arriving at the gate roller 81, the surface of the sheet S which abuts on the intermediate transfer belt 71 in the secondary transfer region TR2 and is to receive a transferred image is at this stage opposite to the surface which already bears the image. In this fashion, it is possible to form images on the both surfaces of the sheet S.

Further, there are a density sensor 60 and a cleaner 76 in the vicinity of the roller 75. The density sensor 60, when needed, optically detects a toner amount which constitutes a toner image which is formed on the intermediate transfer belt 71. To be more specific, the density sensor 60 irradiates light toward the toner image, receives reflection light from the toner image, and outputs a signal corresponding to a reflection light amount. The cleaner 76 is structured to be attached to and detached from the intermediate transfer belt 71, and by abutting on the intermediate transfer belt 71 as needed, the cleaner 76 scrapes off the toner remaining on the belt 71.

Further, as shown in FIG. 2, the apparatus 1 comprises a display 12 which is controlled by a CPU 111 of the main controller 11. The display 12 is formed by a liquid crystal display for instance, and shows, in response to a control command from the CPU 111, predetermined messages which are indicative of operation guidance for a user, a progress in the image forming operation, abnormality in the apparatus, the timing of exchanging any one of the units, etc.

In FIG. 2, denoted at 113 is an image memory which is disposed to the main controller 11, so as to store an image which is fed from an external apparatus such as a host computer via an interface 112. Denoted at 106 is a ROM which stores a calculation program executed by the CPU 101, control data for control of the engine part EG, etc. Denoted at 107 is a RAM which temporarily stores a calculation result derived by the CPU 101, other data, etc.

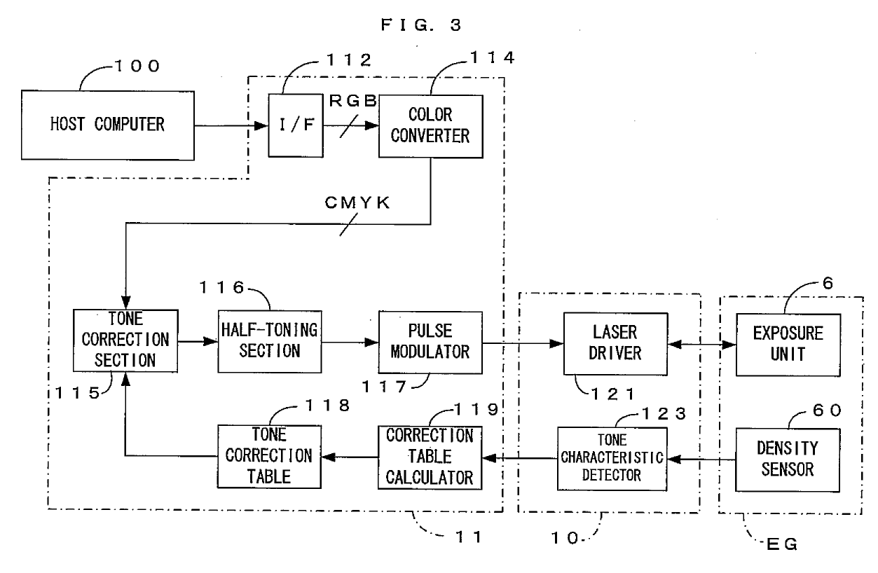

FIG. 3 is a diagram which shows signal processing blocks of the apparatus. In the image forming apparatus, when an image signal is inputted from an external apparatus such as a host computer 100, the main controller 11 performs a predetermined signal processing on the image signal. The main controller 11 includes function blocks such as a color converter 114, a tone correction section 115, a half-toning section 116, a pulse modulator 117, a tone correction table 118, a correction table calculator 119.

In addition to the CPU 101, the ROM 106, and the RAM 107 shown in FIG. 2, the engine controller 10 further includes a laser driver 121 for driving a laser light source provided at the exposure unit 6, and a tone characteristic detector 123 which detects a tone characteristic based on a detection result given by the density sensor 60, the tone characteristic representing a gamma characteristic of the engine EG.

In the main controller 11 and the engine controller 10, these function blocks may be implemented in hardware or otherwise, in software executed by the CPUs 111 and 101.

In the main controller 11 supplied with the image signal from the host computer 100, the color converter 114 converts RGB tone data into CMYK tone data, the RGB tone data representing tone levels of RGB components of each pixel in an image corresponding to the image signal, the CMYK tone data representing tone levels of CMYK components corresponding to the RGB components. In the color converter 114, the input RGB tone data comprise 8 bits per color component for each pixel (or representing 256 tone levels), for example, whereas the output CMYK tone data also comprise 8 bits per color component for each pixel (or representing 256 tone levels). The CMYK tone data outputted from the color converter 114 are inputted to the tone correction section 115.

The tone correction section 115 performs tone correction on the CMYK tone data of each pixel inputted from the color converter 114. Specifically, the tone correction section 115 refers to the tone correction table 118 previously stored in the non-volatile memory, and converts the CMYK tone data of each pixel inputted from the color converter 114 into corrected CMYK tone data according to the tone correction table 118, the corrected CMYK tone data representing corrected tone levels. An object of the tone correction is to compensate for the variations of the gamma characteristic of the engine EG constructed as described above, thereby allowing the image forming apparatus to maintain the overall gamma characteristic thereof in an idealistic state at all times.

The corrected CMYK tone data thus corrected are inputted to the half-toning section 116. The half-toning section 116 performs a half-toning process, such as an error diffusion process, a dithering process or a screening process, and then supplies the pulse modulator 117 with the half-toned CMYK tone data comprising 8 bits per color component for each pixel. The content of the half-toning process varies depending upon the type of an image to be formed. To be more specific, a process of the most suited content for the image is selected based on judgment standards such as the subject image is a monochromatic image or a color image, or else, the subject image is a line image or a graphic image, and then, the selected process is executed.

The half-toned CMYK tone data inputted to the pulse modulator 117 are represented by a multivalued signal which indicates respective sizes and arrays of printing dots of CMYK colors to adhere to each pixel. The pulse modulator 117 which has received the data, using the half-toned CMYK tone data, generates a video signal for pulse width modulation of an exposure laser pulse for each of CMYK color images in the engine EG and outputs the video signal to the engine controller 10 via a video interface not shown. Then, the laser driver 121, which received the video signal, controls ON/OFF of a semiconductor laser of the exposure unit 6 whereby an electrostatic latent image of each of the color components is formed on the photosensitive member 22. The image corresponding to the image signal is formed in this manner.

In the image forming apparatuses of this type, the gamma characteristic varies from apparatus to apparatus. Furthermore, the apparatus per se encounters the variations of the gamma characteristic thereof according to the use conditions thereof. In order to eliminate the influences of the varied gamma characteristics on the image quality, a tone control process is performed at a predetermined timing so as to update the contents of the tone correction table 118 based on measurement results of image density.

In the tone control process, toned patch images for tone correction, prepared in advance for measurement of the gamma characteristic, are formed on the intermediate transfer belt 71 by means of the engine EG. A density of each of the toned patch images is detected by the density sensor 60. Based on signals from the density sensor 60, the tone characteristic detector 123 generates a tone characteristic (the gamma characteristic of the engine EG) which relate the individual tone levels of the toned patch images with the detected image densities and outputs the tone characteristic to the correction table calculator 119 of the main controller 11. Then, the correction table calculator 119 calculates, based on the tone characteristic supplied from the tone characteristic detector 123, tone correction table data for obtaining an idealistic tone characteristic by compensating for the measured tone characteristic of the engine EG, and updates the contents of the tone correction table 118 to the calculation results. The tone correction table 118 is modified in this manner. Thus, the image forming apparatus is able to form images of a consistent quality regardless of the variations of the gamma characteristic thereof or the time-related variations thereof

Next, six embodiments will be described in turn which relate to a structure of a toner counter for calculation of a toner amount consumed in forming toner images in the image forming apparatus which is structured as described above.

### FIRST EMBODIMENT

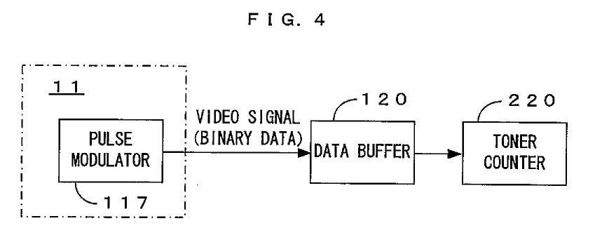

FIG. 4 is a diagram which shows a first embodiment of a toner counter according to the invention. A toner image is composed of a lot of printing dots. A total toner consumption amount is obtained by calculating a sum of a toner amount consumed in forming each of the printing dots. In this embodiment, in order to calculate the toner consumption amount, a data buffer 120 and a toner counter 220 are provided as shown in FIG. 4, the data buffer 120 temporarily storing binary data of a pulse signal (video signal) which is outputted from the pulse modulator 117, the toner counter 220 which calculates the toner consumption amount based on the data stored in the buffer.

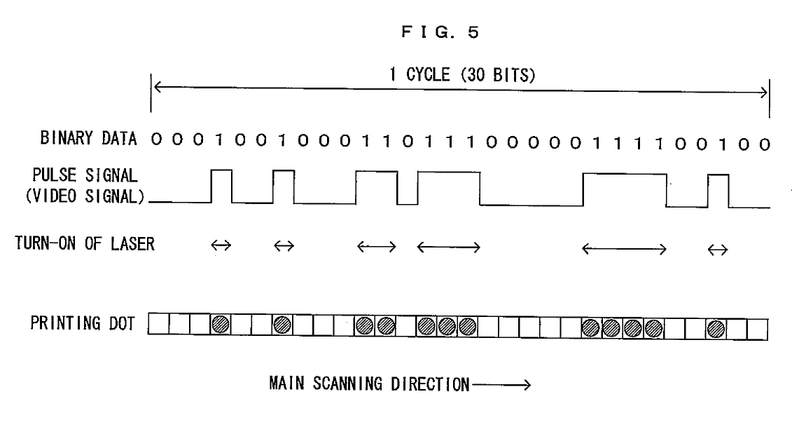

FIG. 5 is a drawing which shows an example of data of a video signal. In this apparatus, the laser light source of the exposure unit 6 scans and exposes the surface of the photosensitive member 22 in one direction (this direction is hereinafter called “main scanning direction”), and the surface of the photosensitive member moves in a direction orthogonal to the main scanning direction (hereinafter called “sub scanning direction”), thereby forming a two-dimensional electrostatic latent image on the surface of the photosensitive member. One cycle of the video signal (pulse signal) which is outputted from the pulse modulator 117 corresponds to one scanning line in the main scanning direction by the exposure unit 6. In the cycle, the laser light source is on during the pulse signal is maintained to “1” (high level), whereas the laser light source is off during the pulse signal is maintained to “0” (low level). In addition, at this stage, the description is made on condition that on and off of the laser is performed by the single dot.

The data buffer 120 has a data length which corresponds to number of dots which it is possible to form in one scanning line, that is, a value of multiplying a length of the scanning line by resolution in the main scanning direction. Then, the data buffer 120 regards the pulse signal described above as a binary data of 1/0, and stores three consecutive words in which one cycle of the binary data or one scanning line of the binary data is one word. For example, in the case where the length of the scanning line is about 20 centimeters and the resolution in the main scanning direction is 600 dots per inch, the length of one word equals about 4700 bits. However, the description is made on condition that one word equals 30 bits for easier comprehension.

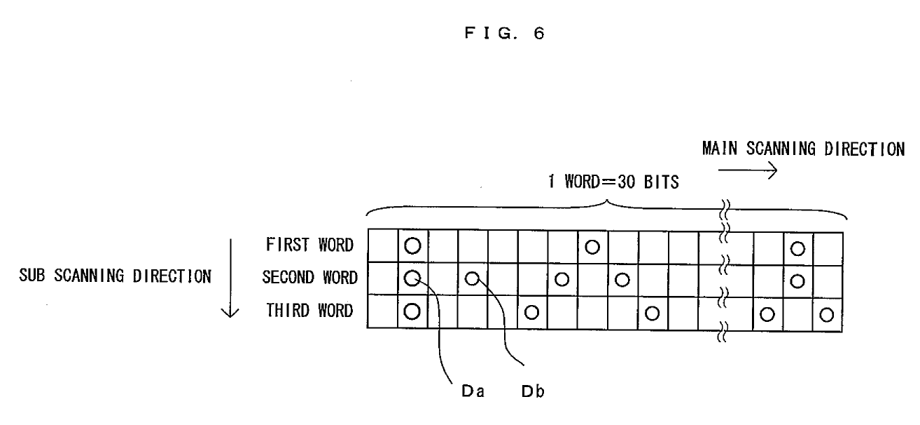

FIG. 6 is a schematic diagram which shows a content stored in the data buffer. In this diagram, a bit of value “1” is indicated by a circle, and a bit of value “0” is indicated by a blank space. When the data of three words are arranged, the state of the distribution of the printing dots in a matrix plane of 30 by 3 dots on the photosensitive member 22 is made clear. For example, regarding a dot denoted at a reference symbol Da, there is another dot one for each above and below. On the other hand, there is no other dot around a dot denoted at a reference symbol Db. From this fact, it is speculated that a toner amount adhered to the dot denoted at a reference symbol Da is larger than that adhered to the dot (isolated dot) denoted at a reference symbol Db due to an interaction between the dot Da and the dots formed around. In the same way, a toner adhesion amount of each of the printing dots formed on the photosensitive member 22 is different depending upon the absence or presence of a printing dot around. In other words, the toner consumption amount to form the printing dot can be estimated based on the number of dots around the dot subject to calculation.

Therefore, the total toner consumption amount to form each of the dots in the matrix plane shown in FIG. 6 is obtained by two methods (1) and (2) shown below. However, only the procedures of calculation of the two methods are different from each other and the results obtained are the same.
(1) a toner consumption amount of each of the dots in the matrix plane is respectively calculated based on the number of dots around, and the amounts of all of the dots are accumulated;
(2) each of the dots in the matrix plane is divided into classes based on the number of dots around, the number of dots in each of the classes are counted, each of the count value is multiplied by a coefficient (which is set for each of the classes) corresponding to a toner amount per dot, and the results are accumulated.

The toner counter 220 in this embodiment calculates the toner consumption amount per page by the method (2) mentioned above, and a specific operation is described hereinafter.

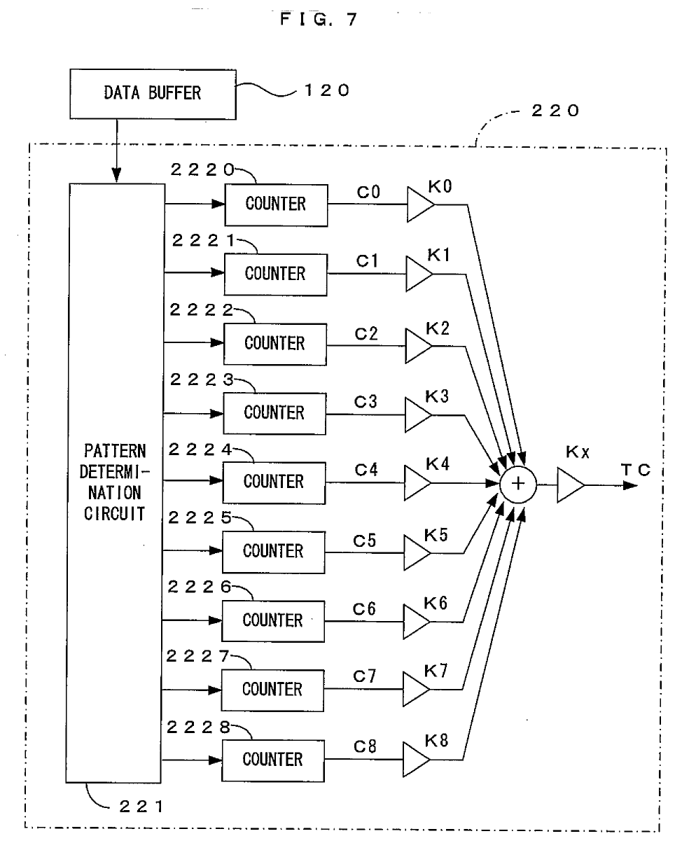

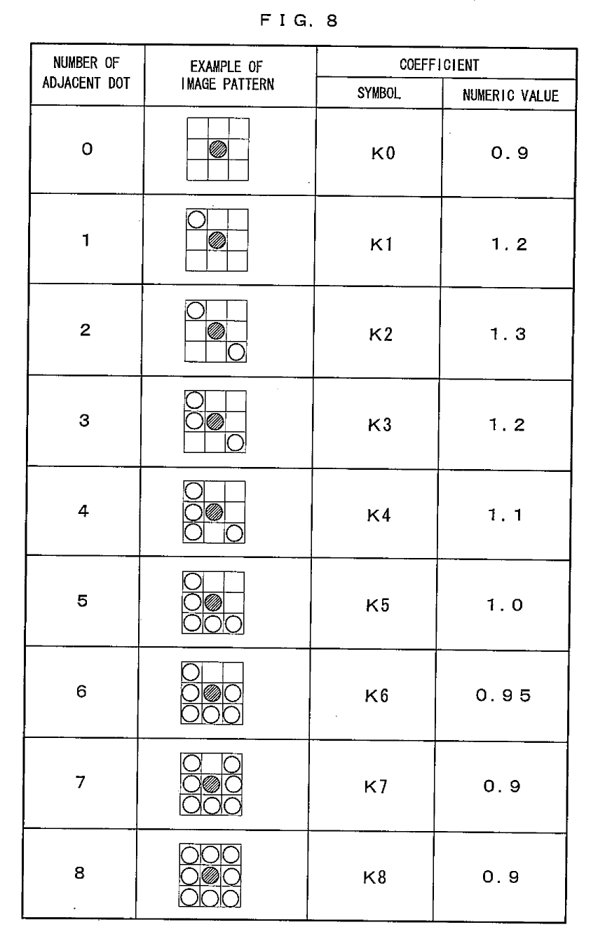

FIG. 7 is a diagram showing a structure of the toner counter of the first embodiment. FIG. 8 is a diagram showing classes of the printing dots based on the number of an adjacent dot. In FIG. 8, the printing dot subject to process is denoted at a mark of a circle with hatching, and an adjacent dot described hereinafter is denoted at a mark of a white circle.

This toner counter 220 comprises a pattern determination circuit 221 which divides, based on data stored in the data buffer 120, each of the printing dots formed in an image of one page into classes depending upon the number of dot formed around the dot subject to calculation. The pattern determination circuit 221 determines, for each of the printing dots, how many dots other than the dot subject to calculation are present in the 3 by 3 matrix plane in which the dot subject to calculation is the center, and outputs value “1” to either one of counters 2220 through 2228 depending upon the determination result. For example, in the case where the printing dot subject to determination is an isolated dot like the dot Db shown in FIG. 7, since the number of adjacent dot equals 0, the pattern determination circuit 221 outputs value “1” to the counter 2220. Whereas, in the case where the number of adjacent dot is two in the 3 by 3 plane like the dot Da shown in FIG. 7, the pattern determination circuit 221 outputs value “1” to the counter 2222. The counters 2220 through 2228 count the number of times the pattern determination circuit 221 outputs value “1” during a predetermined unit time period which corresponds to an image of one page for instance. In this manner, the numbers C0, C1, C2, C3, C4, C5, C6, C7 and C8 which respectively represent, among all of the printing dots which constitute the image of one page, the numbers of adjacent dot being 0, 1, 2, 3, 4, 5, 6, 7 and 8 are counted by the counters 2220, 2221, 2222, 2223, 2224, 2225, 2226, 2227 and 2228 respectively.

Then, when the count of one page is finished, the counters 2220 through 2228 output the count values C0 through C8. The count values C0 through C8 are multiplied by coefficients K0 through K8 respectively, the results are added each other, and then multiplied by a coefficient Kx, whereby the toner consumption amount TC in forming images of the page concerned is calculated. That is, the toner consumption amount TC is obtained by the equation below.
TC=Kx*(K0*C0+K1*C1+K2*C2+. . . +K7*C7+K8*C8) (equation 1)
In addition, in the calculation method (1) described above, each time the printing dot appears, coefficient K0 and the like is selected as a weight of the dot corresponding to the number of adjacent dot, and the values are accumulated for one page. Hence, the toner consumption amount obtained by the method (1) is also the same result indicated by the above-described equation 1.

The coefficients K0 through K8 are weighted corresponding to the difference of the toner amount which adhere to the central dot depending upon the number of adjacent dot. The example shown in FIG. 8 indicates that, to a dot the number of adjacent dot equals 0 (isolated dot) and to a dot the number of adjacent dot equals two for instance, 0.9 and 1.3 times as much as toner adhere compared to a dot the number of adjacent dot is five.

Further, the coefficient Kx is a value corresponding to a toner adhesion amount per dot to a typical dot (a dot the number of adjacent dot equals five in the embodiment). As described above, weightings which correspond to a difference of toner adhesion amount depending upon the number of adjacent dot are made and the results are added each other, whereby the total number of dots is obtained. Then, the total number of dots is multiplied by the coefficient Kx, thereby calculating the toner amount TC consumed in forming images of one page. These coefficients are obtained by way of experiment. To be more specific, various images of different patterns are formed, dots are divided into classes depending upon the number of adjacent dot, the numbers of dots of each of the classes are counted and the toner consumption amount is measured. Then, the coefficients K0 through K8 and Kx are determined so that the measured value and the calculated value coincide with each other as much as possible. In addition, it is necessary to obtain the coefficients individually for each of toner colors.

In addition, according to this calculation method, in order to calculate a toner consumption amount of each of the printing dots which exist on one scanning line individually, data of pulse signal of total of three lines including the scanning line subject to calculation and one line each of before and after (or above and below) thereof are enough. Therefore, in this embodiment, the data buffer 120 stores data of three scanning lines, and when the pattern determination of all the printing dots on one line is finished, clears data of one line which is the oldest, and newly stores the data of the next one line.

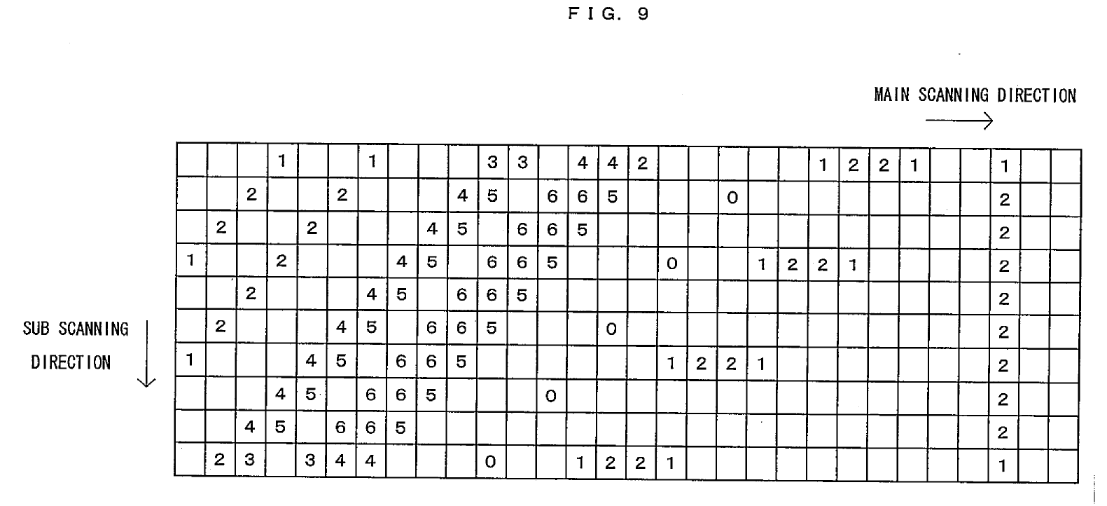

FIG. 9 is a diagram showing an actual example of an arrangement of the printing dots and the toner count. In this example, the toner consumption amount is calculated in the case where one page is composed of 30 by 10 dots. In FIG. 9, a printing dot exists in a section where a numeral is written, and the numeral indicates the number of dots adjacent to the dot subject to calculation. In this example, the total number of the printing dots is 92, and out of that, the numbers C0, C1, C2, C3, C4, C5, C6, C7 and C8 which respectively represent the numbers of adjacent dot being 0, 1, 2, 3, 4, 5, 6, 7 and 8 are 5, 14, 25, 4, 12, 16, 16, 0 and 0, respectively. The “weighted” number of dots is 103, which is obtained by multiplying these numbers C0 through C8 by the coefficients K0 through K8 respectively and by adding the multiplication results. This value is enjoined by an effect of a state of a two-dimensional arrangement on the toner consumption amount which is not considered in a conventional technique which simply counts the number of dots or which only considers the state of one-dimensional continuity. Hence, it is possible to calculate the toner consumption amount in actual images which spread in two dimension.

In addition, the toner consumption amount per page calculated by the toner counter 220 in this manner can be accumulated by the CPU 101 and be stored in the RAM 107 for instance for the management of the expendable supplies of the developers. For example, when the total toner consumption amount reaches a certain value, which means that the remaining amount of toner in the developer is less than a predetermined amount, a message indicating to user the fact that the remaining toner is little, a message prompting to user to change the developer, and the like may be displayed in the display 12.

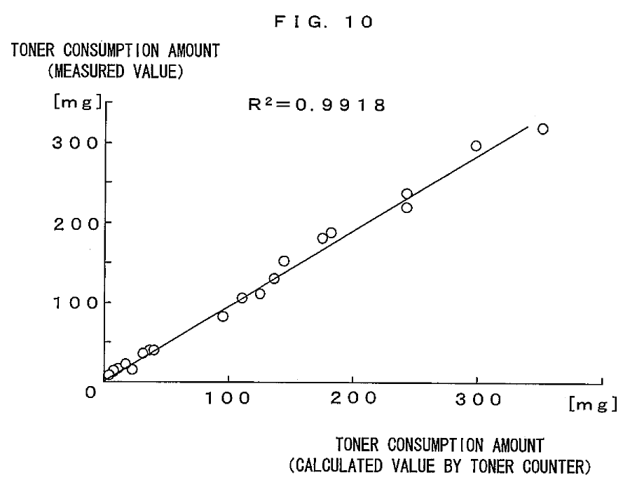

FIG. 10 is a graph showing a matching of the calculated value and the measured value of the toner consumption amount. The toner consumption amount is calculated according to this embodiment in various images and the calculated result is compared with the actual measurement value. As shown in FIG. 10, there is a good proportional relationship between the two (correlation coefficient R2=0.9918). It is confirmed that it is possible to calculate the toner consumption amount accurately using this calculation method.

As described above, in this embodiment, corresponding to the fact that the toner consumption amount of each of the printing dots varies depending upon the presence of a dot around the dot subject to calculation, each of the printing dots is divided into classes according to the number of the adjacent dot and is counted, and the toner consumption amount is obtained based on the count value. Specifically, the classification of the printing dots is performed based on the state of the two-dimensional arrangement, whereby it is possible to obtain the toner consumption amount more accurately than the conventional technique which simply adds the number of dots or which takes into consideration only the state of the one-dimensional arrangement.

In addition, there are cases that toner stored in the individual developers is consumed for use other than the image formation described above. For example, in this kind of image forming apparatus, a phenomenon (fogging) is well known in which a very small amount of toner is adhered to a part where a dot is not supposed to be formed on the surface of the photosensitive member 22. The toner consumption amount by the fogging is not highly correlated with the image patterns, but rather dependent upon the total area of formed images. Therefore, it is possible to obtain the toner consumption amount by the fogging by multiplying a value relating to an image area such as a number of pages of formed images or a driving time of the developer or the like by a certain rate. Further, in the case where a test pattern which is used inside the apparatus and the like are formed without a user's command, it is necessary to calculate the toner amount consumed by these operations separately. The toner amount consumed by the use other than the image formation calculated in this manner is added to the calculating formula described above (equation 1), whereby it becomes possible to obtain the toner consumption amount in the whole of the apparatus. The same holds for the individual embodiments described hereinafter.

As described above, in this embodiment, the photosensitive member 22, the developer unit 4, and the exposure unit 6 function as a “latent image carrier”, a “developing section”, and a “latent image forming section” of the invention respectively. Further, the toner counter 220 functions as a “toner consumption amount calculator” and a “toner counter” of the invention. Further, the data buffer 120 functions as a “storage” of the invention. Further, the 3 by 3 dot-matrix plane in which the center is the printing dot subject to calculation corresponds to a “predetermined area” of the invention.

In addition, in the toner counter 220 in the embodiment above, the printing dots are classified according to the number of dots present in the 3 by 3 matrix plane in which the dot subject to the process is the center, but the invention is not limited to this. The 5 by 5 dots plane in which the dot subject to calculation is the center may be considered for instance. However, it is necessary for the data buffer to store the data of five lines in this case, whereby more storage capacity is needed. Further, the toner adhesion amount of each of the printing dots is strongly affected by the dot which is at a relatively near position, whereas not affected so much by the dot which is at a far position, hence, there is not much merit in obtaining a better accuracy even when the area to include for the process is broadened more than is necessary.

Further, in the embodiment described above, the printing dot is counted per one dot. However, in the actual image forming apparatus, it is possible to control the size of dot more finely by controlling the turn-on time of the laser. It is possible to calculate the toner consumption amount basically in the same light described above even in this case. When the above-mentioned matrix plane is divided more finely, a grid of about 0.1 dot by 0.1 dot for instance, it is possible to respond flexibly to the case where a dot size becomes a broken number. Further, it may be that instead of counting the number of the printing dots per dot, the printing dot whose size is a half of the normal one dot may be counted as a 0.5 dot. Further, the printing dot may be classified according not to the number of the adjacent dots but to the area occupied by the adjacent dots in the predetermined region.

### SECOND EMBODIMENT

In the toner counter of a second embodiment described hereinafter, the calculation method of the toner consumption amount is changed depending upon a content of the process performed in the half-toning section 116. More specifically, the calculation method of the toner consumption amount is changed depending upon the kind of screen applied to the signal processing performed in the half-toning section 116.

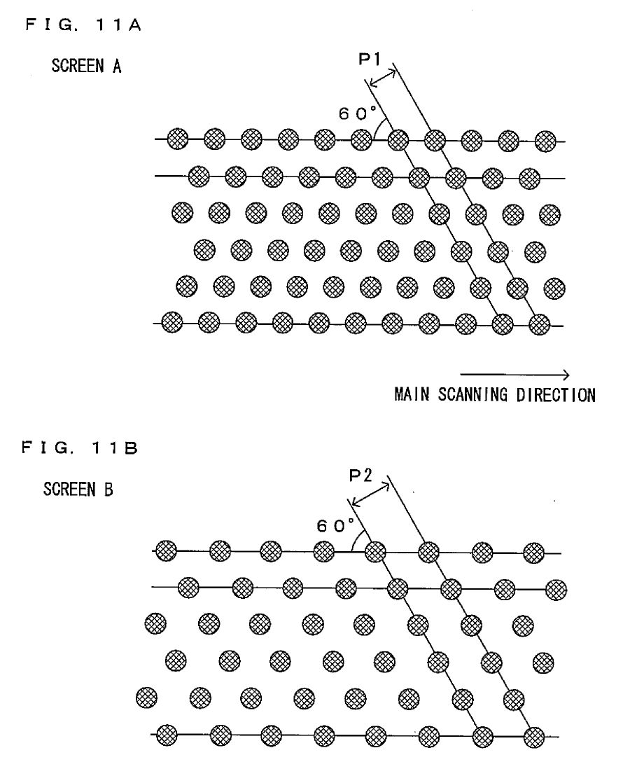

FIG. 11 is a group of drawings which show examples of screens used in the half-toning processing. Two kinds of screens shown in FIGS. 11A and 11B are described here. A first screen (screen A) shown in FIG. 11A is a screen suited for an image which needs a high resolution. That is, this screen A is a screen of a dot structure which has an angle of inclination of 60 degrees to the scanning direction (the main scanning direction) of the light beam L toward the photosensitive member 22, and the pitch P1 of the dots of the screen A is smaller than that of the screen B described hereinafter. In this manner, the screen A, having a comparatively fine pitch P1, is a screen suited for an image which needs a high resolution, an image composed mainly of a character for instance.

On the other hand, a second screen (screen B) shown in FIG. 11B has an angle of inclination of 60 degrees which is the same with the screen A, whereas the pitch P2 of the screen B is larger than that of the screen A. Hence, it is better than the screen A in terms of halftone image representation. That is, the screen B is a screen suited for a graphic image such as a photograph, a natural image and the like.

The half-toning section 116 judges the type of image to be formed based on the inputted image signal, selects one of above-mentioned two kinds of screens suitable for the type of image, and performs the half-toning processing. As a result, in the formed image, the printing dots are arranged having a periodicity corresponding to the pitch of the screen used, and the interval of the printing dots becomes a value corresponding to the pitch. In other words, if the screen used is found out, it is possible to estimate how the printing dots are arranged and having what interval between each other to some extent. In addition, the screen is not limited to the two kinds described above, other screens having different angle of inclination of different pitch may be provided.

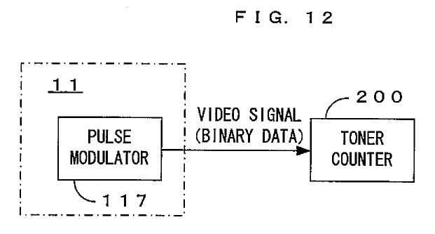

FIG. 12 is a diagram which shows a second embodiment of a toner counter according to the invention. In this image forming apparatus, as shown in FIG. 12, a toner counter 200 which calculates the toner consumption amount based on the video signal outputted from the pulse modulator 117 in the main controller 11 is provided in the engine controller 10. The inventors have come to develop a toner counter described in detail hereinafter based on the results of the various experiments. In addition, although the description is made hereinafter about the result of study performed on the black color toner as a representative example, the same holds for other toner colors.

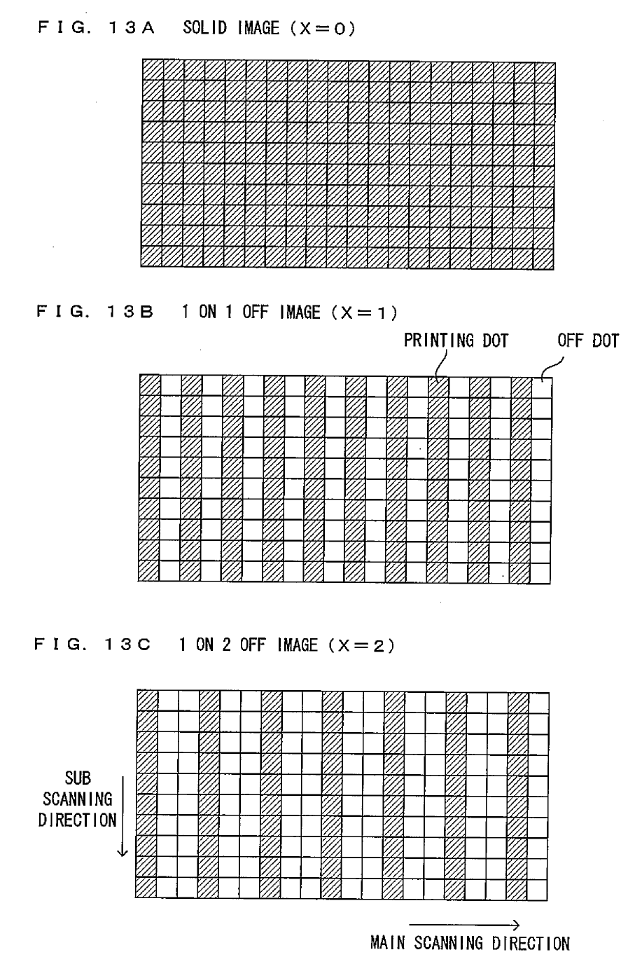

FIG. 13 is a group of drawings which show examples of test patterns used in the experiments. The inventors formed images of test patterns in which the sizes of the printing dots are constant and only the intervals thereof are different variously using the image forming apparatus structured described above, and measured a toner consumption amount per one printing dot of each of the images. In more detail, as shown in FIGS. 13A through 13C, images, composed of plural lines of which the width is 1 dot and the intervals X in-between are different variously, are used as test patterns. An image of the width of lines being 1 dot and the line interval being X dots is hereinafter called “1-on X-off image”. For example, “1-on 1-off image” means an image in which lines of 1-dot width are arranged in parallel with an interval of 1 dot in-between, and “1-on 2-off image” means an image in which lines of 1-dot width are arranged in parallel with an interval of 2 dots in-between. Further, the pattern shown in FIG. 13A is a so-called solid image and is not strictly the 1-dot-line image, but it is treated here as a kind of 1-line image of which a line interval X is zero.

In FIGS. 13A through 13C, “main scanning direction” is a scanning direction of the exposure beam L, and “sub scanning direction” is a direction orthogonal to this direction and is a moving direction of the surface of the photosensitive member 22. In addition, in FIGS. 13A through 13C, a case where the line interval X is an integer, that is, the line interval is an integral multiple of the dot width, is illustrated by an example. However, it is possible to set the line interval X other than an integer value by controlling the turn-on timing of the exposure beam L. In this experiment, measurement was also made in the case where the line interval is other than an integer value. Further, only the test patterns composed of lines which extend in the sub scanning direction are shown as a representative example. This is because the line interval of lines which extend in the sub scanning direction can be set randomly by controlling the turn-on timing of the exposure beam L. On the other hand, since the interval of the lines which extend in the main scanning direction is determined by the moving pitch of the photosensitive member 22 and the scanning cycle of the exposure beam L, it cannot be set to any value. However, the relationship between the line interval and the toner consumption amount show the same tendency of the image composed of lines which extend in the sub scanning direction described above.

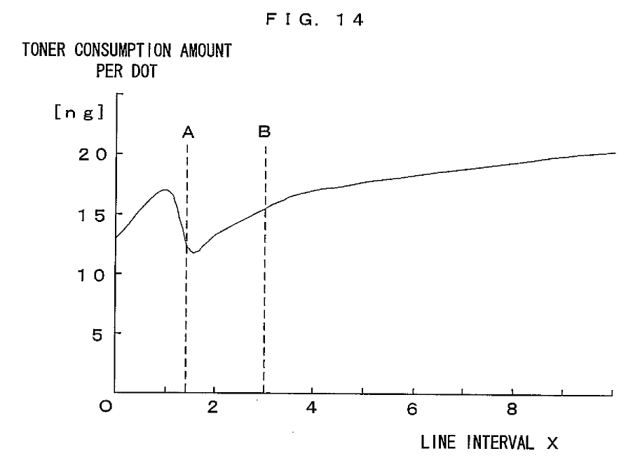

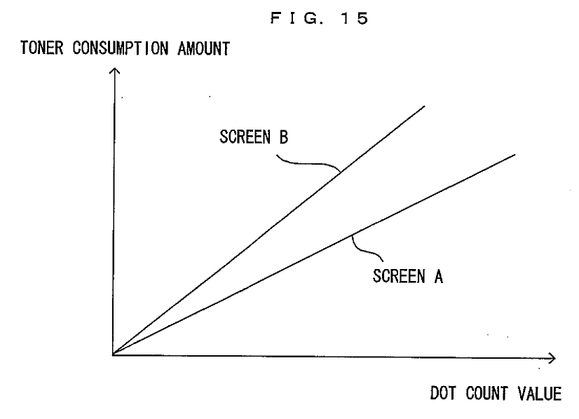

FIG. 14 is a graph showing the relationship between the line interval and the toner consumption amount. FIG. 15 is a drawing which shows the relationship between the dot count value and the toner consumption amount. The result that the toner consumption amount per one printing dot which composes each of the lines varies depending upon the line interval X is indicated as shown in FIG. 14. More specifically, as the line interval X increases from zero (solid image) gradually, the toner consumption amount per dot increases once, then decreases. And after it becomes local minimum at about X=2, it gradually increases toward a certain asymptotic value.

When the pitch in the two kinds of screens A and B described above is converted to the line interval, they become values denoted at broken lines A and B shown in FIG. 14 respectively. In this manner, since each of the two screens has a pitch different from each other, the arrangement pitch of the printing dots is also different, and each of the toner amount per one printing dot in the image which processing is performed using these screens is different from each other. To be more precise, the toner amount per dot in the image which is formed using the screen B is greater than that in the image which is formed using screen A. Therefore, as shown in FIG. 15, even when the number of the printing dots formed is the same, the total amount of the toner consumption amount becomes different. Hence, it is necessary to change the calculation formula depending upon the screen used in the case where the toner consumption amount is obtained based on the counted value of the printing dots.

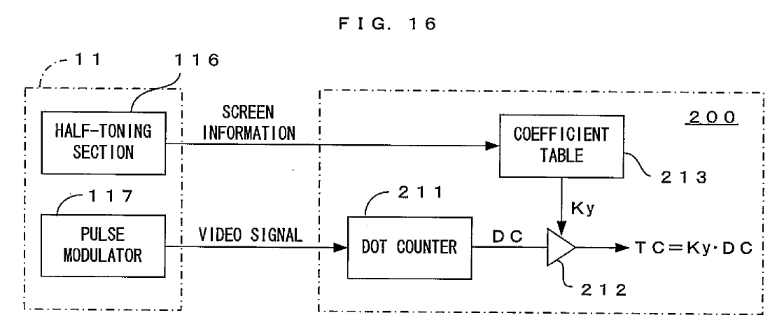

FIG. 16 is a diagram which shows a structure of the toner counter in the second embodiment. This toner counter 200 calculates the toner consumption amount based on the screen information given from the half-toning section 116 and the video signal given from the pulse modulator 117 both in the main controller 11. More in detail, a counter 211 which counts the number of the printing dots formed based on the video signal given from the pulse modulator 117 is provided in the toner counter 200. The counter 211, in a predetermined calculation unit such as one page unit or one job unit or the like, outputs a total counted value DC of the printing dots during the period. The counted value DC outputted from the counter 211 is inputted to a multiplier 212 and is multiplied by a predetermined coefficient Ky. The product TC is the toner consumption amount during the period.

As the coefficient Ky, not a constant value but a value selected from a coefficient table 213 based on the screen information, that is, the information indicating which screen is to be used, given from the half-toning section 116 is used. In an example shown in FIG. 15, the toner consumption amount is greater in the case where the screen B is used than in the case where the screen A is used. Hence, the coefficient corresponding to screen A is greater than that corresponding to screen B, whereby it becomes possible to calculate the toner consumption amount accurately regardless of the difference of the toner amount between the screens described above.

In addition, the dot counter 211 in this embodiment counts simply the number of the printing dots without considering the consecutive state of the printing dots. However, it goes without saying that the counter of a type, similar to the counter described in the Patent Document 1 mentioned above, which divides the printing dots into classes depending upon the consecutive state of the printing dots, counts them individually, multiplies them by a predetermined weight, and accumulates them may be used. Further, the weight may be changed depending upon the kind of the screen used. Further, not the number of the printing dots but the number of a group of the printing dots composed of the successive printing dots may be counted. That is, it may be that the number of a group of the printing dots composed of one printing dot or successive plural printing dots is counted for each of the length, each of the counted values is multiplied by a coefficient corresponding to the length of the group, and then accumulated.

Further, there may be a case that plural areas in which the screen used are different from each other are included during the period subject to calculation depending upon the formed image. In a case like this, since the toner consumption amount per dot is different in each of the areas, it is necessary to calculate the toner consumption amount for each of the areas individually.

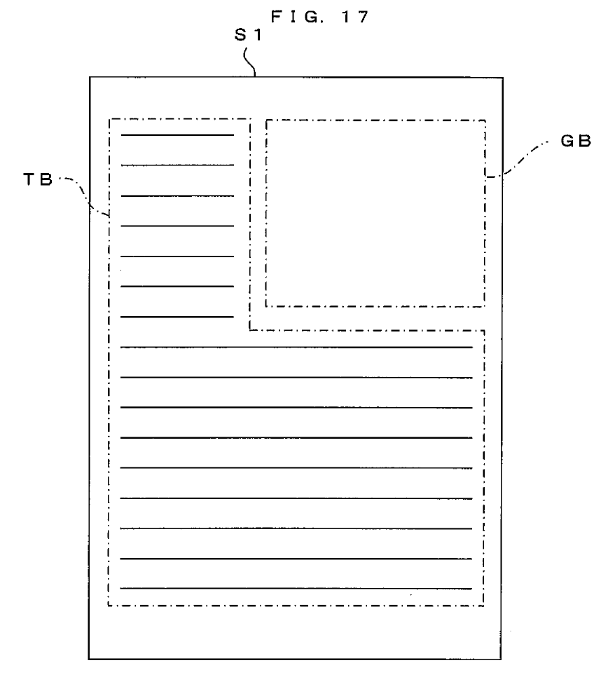

FIG. 17 is a drawing which shows an example of an image in which text and graphic are mixed. An example that a text block TB composed mainly of a character image and a graphic block GB in which photos and the like are pasted are mixed is considered here. In the image like this, the screen A which is excellent in resolution is used for the text block TB. On the other hand, the screen B which is excellent in expression of half-toning is used for the graphic block GB in which photos and the like are pasted. Therefore, it is preferable that the toner consumption amount in the text block TB and the toner consumption amount in the graphic block GB are calculated using a method different from each other.

As described above, in this embodiment, the toner consumption amount is calculated based on the number of the printing dots. In this case, in view of the fact that the toner consumption amount is different depending upon the distribution state of the printing dots, the calculating method of the toner consumption amount is varied depending upon the content of the signal processing executed to the image signal given from the external apparatus, to be more specific, depending upon the kind of the screen used in the half-toning processing. In this manner, it becomes possible to calculate the toner consumption amount accurately regardless of the difference of the toner adhesion amount per dot due to the difference of the pitch of the screen.

More specifically, when the screen A whose pitch is fine is used, since the toner consumption amount per one printing dot is greater than in the case where the screen B whose pitch is rough is used, the coefficient Ky to multiply the dot count value is made greater value than in the case of the screen B. In this manner, in accordance with the difference of the toner consumption amount caused by the fact that the distance between the printing dots of the individual screen is different, it is possible to calculate the toner consumption amount accurately when either screen is used.

Further, in the toner counter in the embodiment above, the toner consumption amount is obtained based on the video signal fed to the laser driver. The pulse width of the pulse signal like this is an information directly indicating the successive state of the printing dot and the off dot, hence it is possible to understand easily the size of the group of the printing dots and the group of the off dots (or the number of dots which compose the groups).

As described above, in the above embodiment, the engine part EG and the main controller 11 function as an “image forming section” and a “signal processor” of the invention respectively. Further, in the above embodiment, the toner counter 200 functions as a “toner consumption amount calculator” and a “toner counter”.

In addition, as described above, the feature of this embodiment is to change the toner consumption amount calculating method by means of the toner counter 200 depending upon the kind of the screen used, hence about the structure and the calculating formula for calculating the toner consumption amount, other known techniques may be applied other than the ones described above. Therefore, other than the method to change the coefficient as in the above embodiment, two kinds of toner counters may be provided which are optimized for the individual screens and used by changing them corresponding to the kind of the image for instance.

Further, in the above embodiment, in the case where a text image block and a graphic image block are mixed in an image of one page, the toner consumption amount is obtained for the individual blocks respectively. Other than this method, the toner consumption amount may be obtained for the individual blocks in a unit of smaller block (dot matrix of several dots by several dots for instance).

Further, in the case where a distribution state of the printing dots in a formed image can be estimated based on the content of the image signal fed from the external apparatus or on the progress of the signal processing, the toner consumption amount calculating method may be changed based on the estimation. For instance, in an image in which a uniform background color is set in a whole or a part of the formed image, it is possible to estimate to a certain degree in what density and in what arrangement the printing dots are formed in the background part, based on the specified content of the background color or the density. In a case like this, as to the background part, it is possible to enhance the accuracy of the toner consumption amount calculation by selecting the calculation method in accordance with the estimated distribution state of the printing dots.

### THIRD EMBODIMENT

As described in the Patent Document 1 and as described in the first embodiment, the toner consumption amount of one printing dot is affected by the presence or absence of other printing dots in the vicinity of the printing dot subject to calculation. This is because the latent image profiles corresponding to the respective printing dots interfere with each other on the photosensitive member 22. Consequently, in the two-dimensional toner count technique, the toner consumption amount of each of the printing dots is obtained based on the number of other printing dot (adjacent dot) which is present in the (M by N)-dot matrix the center of which is the printing dot subject to calculation, where M and N are natural numbers.

It is possible to calculate the toner consumption amount of each of the printing dots using a table which indicates a relationship between the number of adjacent dot in the M by N dot matrix the center of which is the printing dot subject to calculation and the toner adhesion amount. More specifically, a table is created in which the toner adhesion amount of the printing dot corresponds to the number of the adjacent dot. And in obtaining the toner consumption amount of a certain printing dot, the number of the adjacent dot of the printing dot subject to calculation is obtained, and the table is referred based on the number, whereby the toner consumption amount of the printing dot subject to calculation is obtained. Then, the toner consumption amount of each of the printing dots is accumulated in a predetermined calculation unit, in 1-page-image unit for instance, whereby the total toner consumption amount in the unit is obtained. According to the knowledge of the inventors, it is preferable to change the size of the matrix in accordance with the content of the image to form rather than to keep it to a constant value.

For example, in an image in which a halftone is frequently used such as a photographic image and the like (hereinafter called a “halftone image”) the printing dots of a various tone level are distributed adjacent to one another and over a large area. In an image like this, the toner consumption amount of each of the printing dots greatly depends upon the state of other printing dots which exist around it. Therefore, in dealing with an image like this, it is effective to enlarge the size of the matrix comparatively in enhancing the accuracy of the toner consumption amount calculation.

On the other hand, in an image based on a line of a constant density and a uniform solid pattern and the like such as a character and a chart and the like (hereinafter called a “line-based image”), many printing dots having the same tone level (especially the maximum tone level and the minimum tone level) are often in succession, and halftone is not frequently used, hence the arrangement of the printing dots is comparatively simple compared to the halftone image. In an image like this, it is less affected to the calculation accuracy even when the size of the matrix is small. On the contrary, it is possible to simplify the calculation process in this manner.

Further, in a color image for example, since intended color is obtained by mixing the toner of each color in a appropriate balance, the printing dots having halftone level are formed from a point of view of each toner color. On the other hand, in a monochromatic image composed only of a single toner color, good reproducibility of halftone is not often required, and a pattern is comparatively monotonous. Therefore, it is preferable to change the size of the matrix for obtaining the toner consumption amount also depending upon whether the formed image is color or monochromatic.

Further, in the apparatus of this type, there is a case that the screen processing is performed using different screens for each toner color in order to prevent a moire pattern from appearing in a color image. In this case, it is preferable to change the size of the matrix for each toner color corresponding to a mode of the screen used.

Consequently, in this image forming apparatus, a table is provided for each of the two sizes of the matrix, (3 by 3) and (3 by 5) as described hereinafter, the table indicating the relationship between the number of the adjacent dot and the toner adhesion amount of the printing dot of the center. And the tables are selectively used according to the content of the image to be formed.

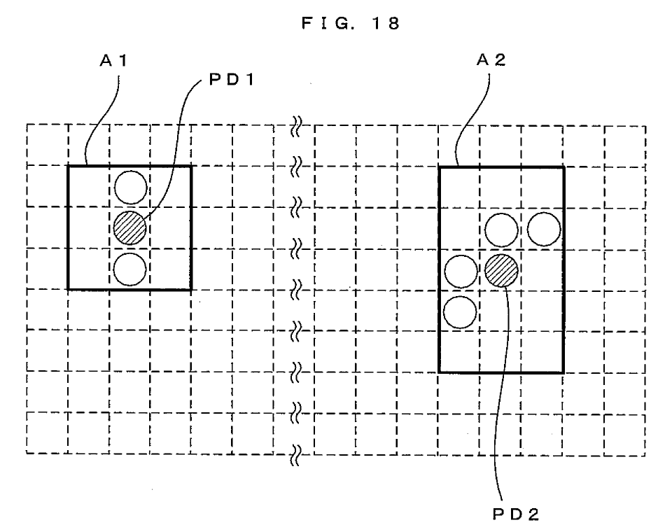

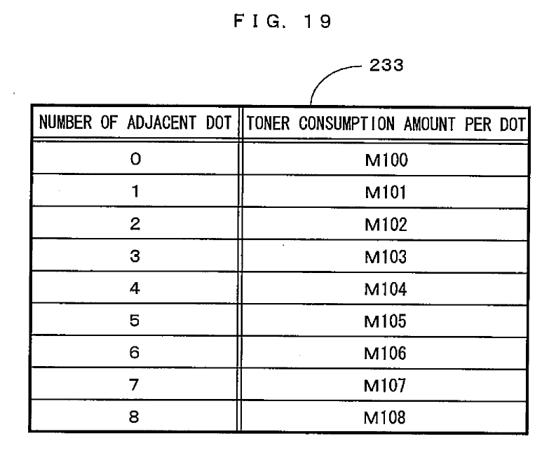

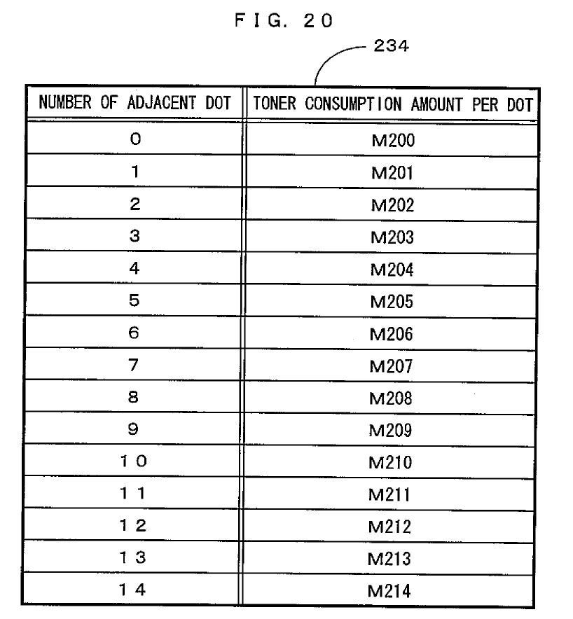

FIG. 18 is a drawing which shows an example of a state of arrangement of the printing dots on the photosensitive member. Further, FIG. 19 is a drawing which shows a first table which corresponds to a (3 by 3) matrix. Furthermore, FIG. 20 is a drawing which shows a second table which corresponds to a (3 by 5) matrix. When the (3 by 3) matrix is selected, the toner consumption amount of the printing dot PD1 shown in FIG. 18 is obtained by referring to the first table based on the number of other printing dots (the number of the adjacent dots) in an area A1 of 3 dots by 3 dots, the center of which is the printing dot subject to calculation. When the number of the adjacent dots is two as shown in FIG. 18 for instance, the first table 233 is referred, and the value M102 is obtained as the toner consumption amount of the printing dot PD1. The toner consumption amount of each of the printing dots is obtained in this manner, the obtained amounts are summed up, which is a total toner consumption amount.

Further, when the (3 by 5) matrix is selected, the second table 234 is referred based on the number of the adjacent dots in an area A2 of 3 dots by 5 dots, the center of which is the printing dot subject to calculation, and the toner consumption amount of the printing dot PD2 shown in FIG. 18 is obtained. When the number of the adjacent dots is four as shown in FIG. 18 for instance, the value M204 is obtained as the toner consumption amount of the printing dot PD2.

In this example, the tables are switched based on the information fed from the main controller 11. In the main controller 11, signal processing such as the color converting processing, the screen processing and the like are executed on the image signal fed from the host computer 100. Therefore, an information concerning the image to be formed being either color or monochromatic, an information concerning toner color to which the toner image currently being formed corresponds, or an information concerning the kind of screen used in executing the signal processing, or the like have to be grasped in the main controller 11. Consequently, these pieces of information are utilized as a switching information for switching the tables.

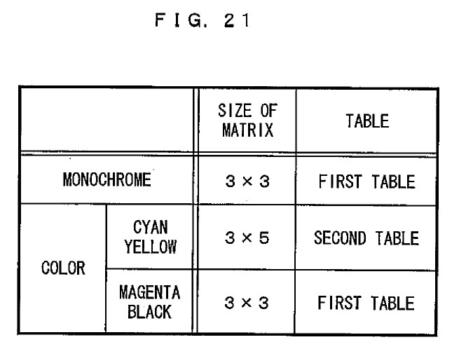

FIG. 21 is a drawing which shows a mode of selection of the matrixes and the tables. In this apparatus, the screen processing is not executed on the image signal when the monochromatic image of the black color is formed. Consequently, in the case where the video signal outputted from the pulse modulator corresponds to the monochromatic image, the small size (3 by 3) matrix is selected and the first table 233 is selected. On the other hand, in the case where the video signal corresponds to the color image, two kinds of matrixes are selectively used depending upon the toner color. The reason is as follows.

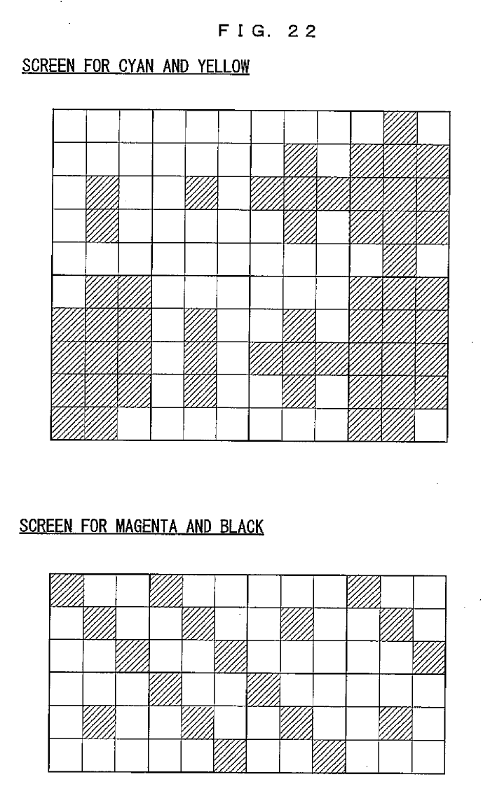

FIG. 22 is a group of drawings for describing the difference of the applied screen for each toner color. In forming a color image, two kinds of screens are selectively used depending on color in order to prevent a moire pattern from appearing in the image. As shown in FIG. 22, a dot-growing screen is applied for cyan color and yellow color, whereas a line-growing screen, whose screen angle is 45 degrees, is applied for magenta color and black color. Since the state of arrangement of the printing dots is different due to the difference of the screens mentioned above, the (3 by 3) matrix and the first table are selected for cyan color and yellow color, whereas the (3 by 5) matrix and the second table are selected for magenta color and black color. In addition, it is preferable to set the numeric values of each table individually for each toner color.

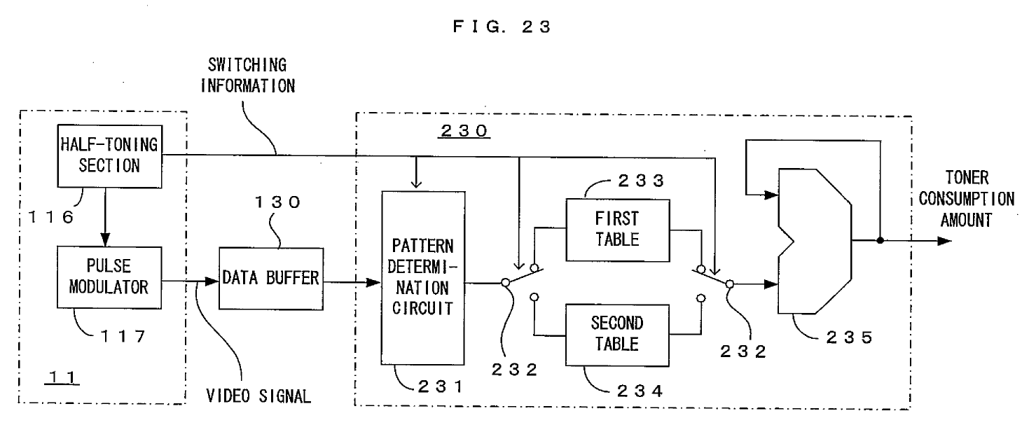

FIG. 23 is a diagram which shows a structure of a toner counter of a third embodiment. In a toner counter 230, a pattern determination circuit 231 for obtaining the number of the adjacent dot, two tables 233 and 234 described above, a selection switch 232 for selecting either one of these tables, and an accumulator 235 which calculates a cumulative sum of the outputs of the table are provided. Further, a data buffer 130 is provided in the engine controller 10, in which video signal which is outputted from the pulse modulator 117 of the main controller 11 is temporarily stored as binary data.

The pattern determination circuit 231 obtains the number of the adjacent dot in the matrix which is specified based on the switching information given from the main controller 11 and the criteria of FIG. 21. One of the two tables which is selected by the selection switch 232 based on the information given from the main controller 11 and the criteria of FIG. 21 is referred to according to the number of the adjacent dot thus obtained and the toner consumption amount of the single printing dot is inputted into the accumulator 235. In the accumulator 235, by accumulating the output from the table for a predetermined unit period, for 1-page-image unit for instance, it is possible to calculate the toner consumption amount during the unit period.

In addition, the description is made above about the case where the tone level of each of the printing dots is either 100% or 0%, the above concept may be applied to the case where each of the printing dot has the halftone level. More specifically, the number of the adjacent dot which exists in the matrix is not used as the number of the adjacent dot. All the tone levels of the adjacent dot is accumulated, and the quotient of the accumulation divided by the 100% tone level (level 255) is used instead. Further, regarding the toner consumption amount of each of the printing dots also, the value obtained from the table is multiplied by the tone level which the printing dot subject to calculation has and then it is divided by 255, and the quotient may be used. Further, in this case, it is preferable to use multiple data outputted from the half-toning section 116 instead of video signal outputted from the pulse modulator 117.

Further, there are cases that a part of toner stored in the developer is consumed as the so-called fogging or scatters into the inside of the apparatus from the developing roller 44, without contributing to the formation of the toner image. Since the amount of toner like this cannot be obtained by the method described above, the amount of toner like this is estimated by means of other proper method, the estimation is added to the toner consumption amount obtained by the toner counter 230 described above, whereby the remaining toner amount in the developer is calculated more accurately.

Further, the toner consumption amount calculated in this manner may be added cumulatively in the CPU 101, the result may be stored in the RAM 107 and be used for the management of the expendable supplies of the developers. For example, when the total toner consumption amount reaches a certain value, which means that the remaining amount of toner in the developer is less than the predetermined amount, a message indicating to user the fact that the remaining toner is little or a message prompting to user to change the developer may be displayed in the display 12.

Next, a description is made about a method of determining the content of the video signal without using the information from the main controller 11. As described above, it is preferable to change the size of the matrix depending upon whether the formed image being halftone image or the line-based image. However, it is not always easy to determine between the two. For example, there is an image which includes a photograph even though it is monochromatic, and there is also an image of character which is made using halftone. Therefore, there can be a case where it is undesirable to determine the size of the matrix based only on the simple criterion such as color image or monochromatic image and the like. The method described hereinafter is a determination method which can be applied to the case like this.

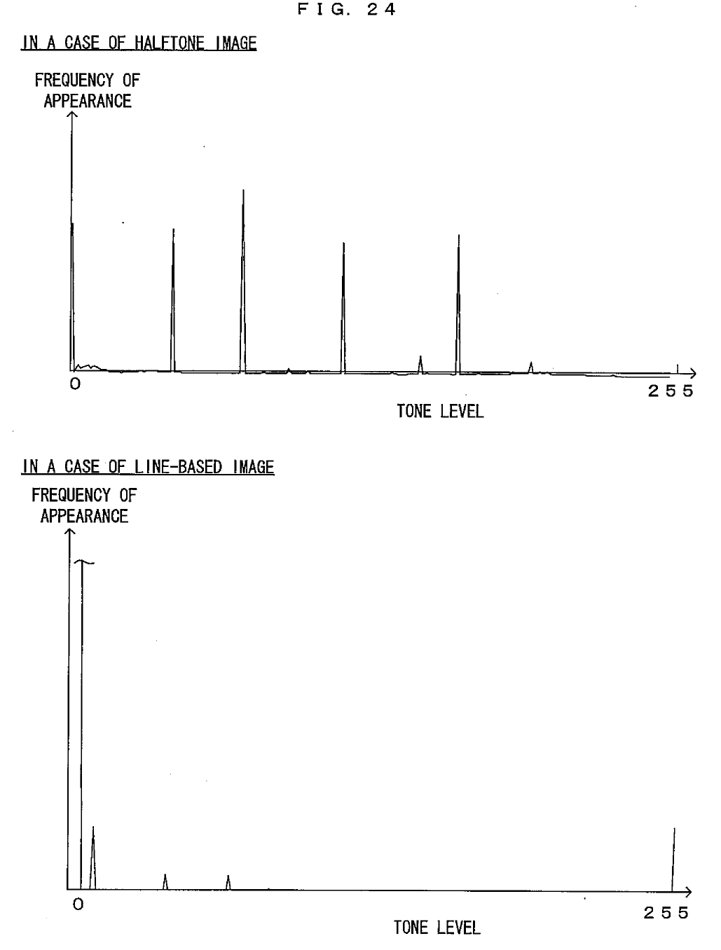

FIG. 24 is a group of drawings which show a relationship between the image content and the frequency of appearance of the printing dot having the various tone level. On studying the frequency of appearance of the printing dot having the various tone level in a predetermined unit, 1-page unit for instance, there is a marked difference between the halftone image such as a photographic image and the like and the line-based image such as a character image and the like as shown in FIG. 24. In more detail, the frequency of appearance of the printing dot having the tone level of around 100% tone level (level 255) and around 0% tone level (level 0) is protruding in the line-based image. Whereas in the halftone image, the printing dot having the tone level of gray appears more often. It is possible to determine whether the image to be formed should be classified as halftone image or the line-based image using this characteristic.

For example, it is possible to determine that the image is a line-based image when the ratio of the number of the printing dots having 100% tone level to the total number of the printing dots is not less than a predetermined value. However, since the line-based image which has a large solid part may be determined erroneously when the dots having 0% tone level are included into the total number of the printing dots, it is preferable to subtract the number of the printing dots having 0% tone level from the total number of the printing dots.

Further, it is possible to determine that the image is a halftone image when the ratio of the number of the printing dots having halftone (the printing dots having not less than 10% tone level and not over than 90% tone level for instance) to the total number of the printing dots is not less than a predetermined value for example. Furthermore, it is possible to determine that the image is also a halftone image, when there is a tone level of which the frequency of appearance of the printing dots is more than a predetermined value among the tone levels which belong to halftone.

In this manner, it is possible to determine the content of the image to be formed by analyzing the content of the video signal without the use of the information from the main controller 11. In this way, although the process becomes complex, it is possible to calculate the toner consumption amount in a manner adapted to the content of the image, and it is possible to improve further the calculation accuracy of the toner consumption amount. In addition, this method can be applied to the embodiments described hereinafter.

As described above, in this embodiment, the video signal generated in the main controller 11 is temporarily stored in the data buffer 130, the two-dimensional state of arrangement of the printing dots is estimated based on the content thus stored, and the amount of toner consumed in forming each of the printing dots is obtained. Therefore, it is possible to obtain the toner consumption amount more accurately than the conventional technique which takes into consideration of the state of arrangement only in one direction. Further, the size of the area to consider the state of arrangement of the printing dots, that is, the size of the area represented by the above-mentioned matrix is set in accordance with the content of the image represented by the video signal, whereby the calculation of the toner consumption amount is executed accurately and efficiently. Especially, it is possible to enhance the calculation accuracy when the size of the matrix is enlarged, whereas it is possible to simplify the calculation process when the size is reduced. And the calculation of the toner consumption amount is executed accurately and efficiently by selectively using these two.

As described above, in this embodiment, the main controller 11 and the engine part EG function as a “signal processor” and an “image forming section” of the invention respectively. Especially, the photosensitive member 22 functions as a “latent image carrier” of the invention. Further, the video signal outputted from the main controller 11 corresponds to “printing-dot data” of the invention. Further, in this embodiment, the toner counter 230 functions as a “toner consumption amount calculator” of the invention. Further, in this embodiment, the areas A1 and A2 on the photosensitive member 22 which are represented by the matrix of (3 by 3) and (3 by 5) corresponds to a “surface area subject to calculating process” of the invention. Further, the data buffer 130 functions as a “storage” of the invention.

In addition, in the embodiment above, although two kinds of matrix composed of (3 by 3) dots and (3 by 5) dots are used, the size of the matrix is not limited to these but set randomly and the variation may be more than two kinds.

Further, in the above embodiment, the screen processing is not executed when a monochromatic image is formed. However, the screen processing may be executed always in forming a monochromatic image or only when needed. And it is possible to set the size of the “surface area subject to calculating process” of the invention properly depending upon whether the screen processing is executed or not, or upon the kind of the applied screen.

Further, in the above embodiment, the processing screen in forming a color image is set to two kinds. However, a different processing screen may be applied for each color as a matter of course. In that case, the size of the “surface area subject to calculating process” may be set for each toner color individually.

### FOURTH EMBODIMENT

Next, a fourth embodiment of a toner counter in the image forming apparatus according to the invention is described. In this embodiment, a toner image is divided into minute unit segment, and the toner consumption amount of each of the unit segments is calculated individually. And the toner consumption amount of each of the unit segments is added up, whereby the toner consumption amount of the entire toner image is obtained. Further, the size of the unit segment is not constant but set to a size in accordance with the content of the formed toner image.

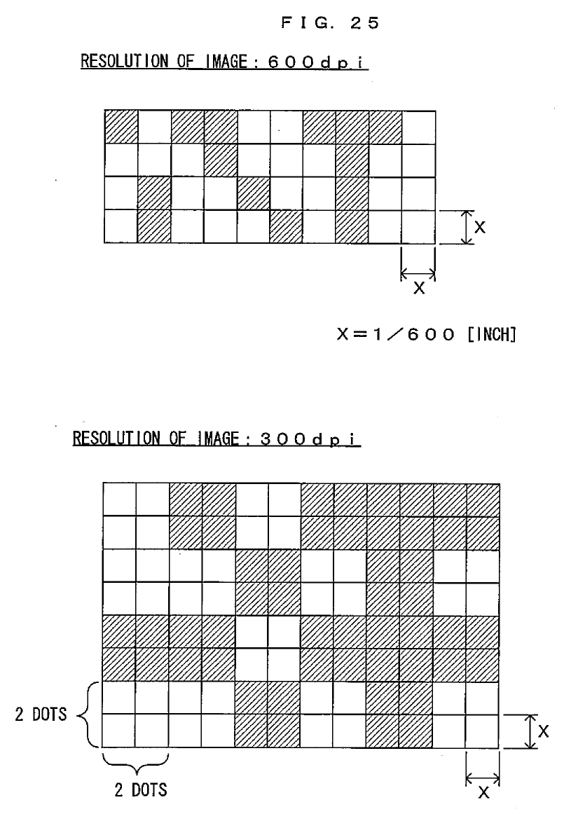

FIG. 25 is a group of drawings which show examples of the setting of the unit segment. The description is made here on the condition that a maximum resolution of this image forming apparatus is 600 dpi (dots per inch). The term “maximum resolution” here is a resolution determined by the structural restriction of the apparatus such as a processing ability of the CPU 101, a storage capacity, the spot size and the scanning speed of the exposure beam, the moving speed of the photosensitive member 22, and the like. That is, the minimum dot that can be formed in this apparatus is 1/600 inches in diameter.

On the other hand, the resolution of the video signal given from the external does not necessarily coincide with this. For example, the video signal is generated in high resolution by the photo-retouching software of personal computers, whereas the video signal which indicates images composed of characters and simple charts generated by text editors, the word-processing software, and the like is often generated in lower resolution. Further, there are cases that the user selects low resolution and generates data on purpose in order to compress the size of files and to reduce the processing time.

In this manner, the video signal given to the apparatus is in various resolutions, but the operation itself of the apparatus does not change significantly by that. As shown in FIG. 25, in the case where an image of 600 dpi in resolution is formed for instance, the dot is turned on and off in a unit of the minimum dot of the apparatus and the toner image is formed. On the other hand, in the case where the resolution of the image is 300 dpi, the size of one dot does not become 1/300 inches. The minimum dot ( 1/600 inches) is turned on and off in the unit of (2 by 2) dots, whereby the apparent resolution becomes 300 dpi.

In obtaining the toner consumption amount, it is necessary to calculate for each dot for the image of 600 dpi in resolution, whereas for the image of 300 dpi in resolution, it is not necessary to calculate for each dot and it is enough to calculate in the unit of 4 dots (2 by 2 dots). Consequently, in this apparatus, the toner consumption amount is calculated for each unit segment, the unit segment being one dot for the image of 600 dpi in resolution, whereas the unit segment being 4 dots (2 by 2 dots) for the image of 300 dpi in resolution. In this manner, the unit segment is set in accordance with the resolution of the image to be formed, and the toner consumption amount is obtained, whereby the toner consumption amount is calculated accurately and efficiently.

Next, the effect of the screen processing in forming a color image is considered. A color image is formed by superimposing the toner images of each color in proper balance. In this case, when the respective arrangements of the printing dots which compose the toner images of each color have the same periodicity, there may appear a moire pattern in the superimposed image, which leads to the deterioration of the image quality. Consequently, the periodicity of the printing dots is shifted for each color, whereby the moire pattern is prevented from becoming conspicuous. As the processing for this, it is possible to realize it by varying the screen applied for each color, in executing the screen processing on the image data of each color in the half-toning section 116.

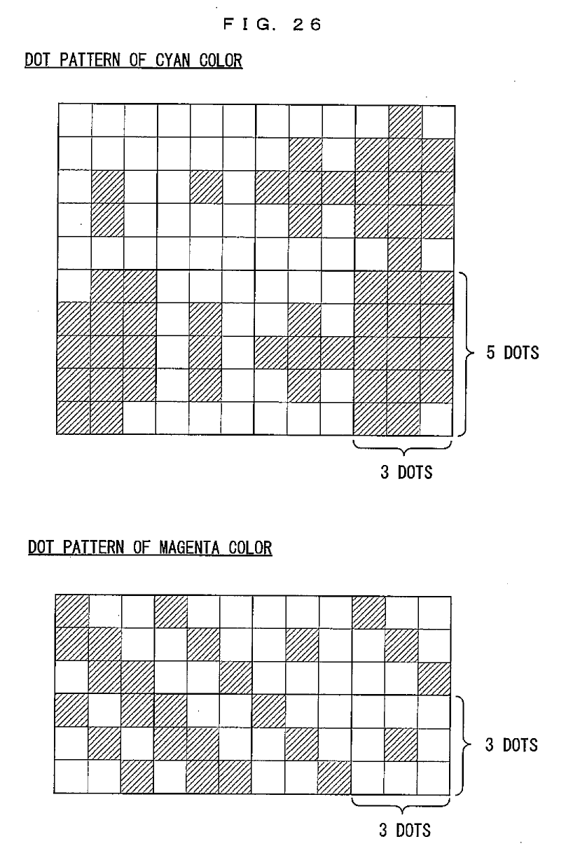

FIG. 26 is a group of drawings which show examples of the arrangement pattern of the printing dots after the screen processing is executed. As shown in FIG. 26, the screen processing is executed on the image data of the cyan color in (3 by 5)-dot unit, the processing varying the size of the point as an assembly of the printing dots (point-growing screen processing). Whereas, the screen processing is executed on the image data of the magenta color in (3 by 3)-dot unit, the processing varying the width of the line of which the slope is 45 degrees and which is as an assembly of the printing dots (line-growing screen). As a result of the screen processing like this, in the arrangement pattern of the printing dots after the processing, a characteristic repetitive pattern in (3 by 5)-dot unit appears as to the cyan color, and in (3 by 5)-dot unit as to the magenta color.

For this reason, it is convenient that the size of the unit segment which is a unit of the toner consumption amount calculation coincides with the unit of the repetition mentioned above. That is, since it is known that the printing dots are arranged in (3 by 3)-dot unit in magenta color for instance, the (3 by 3) dot is defined as the unit segment. Furthermore, the arrangement of the dots inside the (3 by 3)-dot matrix has a regularity (linear arrangement of which the slope being 45 degrees in this example), which limits a combination of the dot arrangement to several different kinds. Therefore, it is possible to calculate the toner consumption amount for each combination in advance. The calculation for obtaining the toner consumption amount of the entire toner image is realized by the method of calculating the toner consumption amount for each unit segment in accordance with the dot pattern, and adding up the toner consumption amount for each unit segment, whereby the calculation is greatly simplified compared to the method of calculating for each dot. In the same way, (3 by 5) dots may be defined as the unit segment for cyan color. The same applies to other colors.

Next, the description is made about an example of a specific structure of a toner counter which calculates the toner consumption amount using the principal described above.

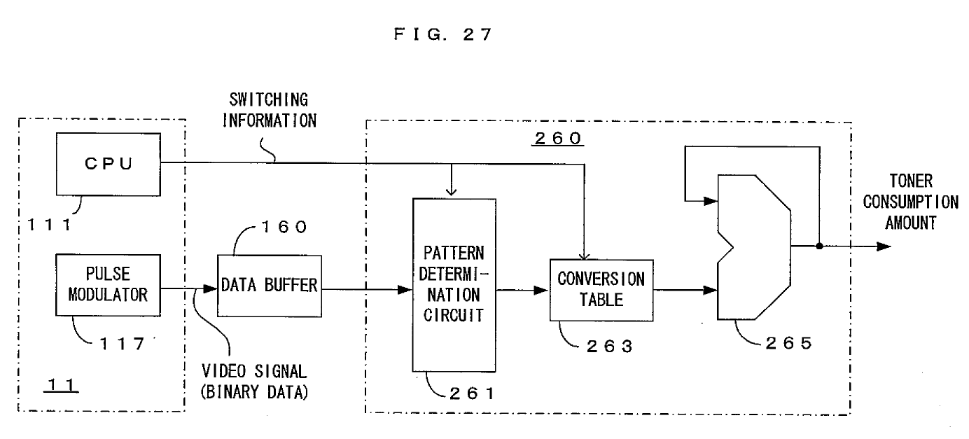

FIG. 27 is a diagram which shows a structure of a toner counter in a fourth embodiment. As shown in FIG. 27, a toner counter 260 comprises a pattern determination circuit 261, a conversion table 263 and an accumulator 265. Further, in this apparatus, a data buffer 160 is provided for storing temporarily a video signal which is outputted from the pulse modulator 117 in the main controller 11 and which is binary data indicating on and off states of dots.

The pattern determination circuit 261 determines the state of the arrangement of the printing dots of a toner image based on the binary data stored in the data buffer 160 and outputs the determination result. And the conversion table 263 refers to a built-in look-up-table and outputs a value which corresponds to data which is outputted from the pattern determination circuit 261. The accumulator 265 accumulates and stores the values outputted from the conversion table 263. Further, “switching information” from the CPU 111 which is provided in the main controller 11 is inputted into the pattern determination circuit 261 and the conversion table 263. This “switching information” is information which indicates the content of an image to be formed being either one of three kinds, namely (1) a image is in high resolution (600 dpi) and monochromatic; (2) a image is in low resolution (300 dpi) and monochromatic; and (3) a image is in color. Further, in the case where an image to be formed is a color image, information is also added which indicates the toner color of the toner image being currently formed. And the functions of the pattern determination circuit 261 and the conversion table 263 change as described hereinafter depending upon the content of the information.

(1) In the Case Where a Image is in High Resolution (600 dpi) and Monochromatic;

In this case, the toner counter 260 calculates the toner consumption amount, one dot being defined as the unit segment. That is, the toner consumption amount for each dot is calculated, and then the results are added up, whereby the toner consumption amount of the entire toner images is obtained. The content of the specific process is as follows.

The toner consumption amount of a single printing dot is affected by the presence or absence of other printing dots in the vicinity of the printing dot subject to calculation. It is because the latent image profiles which correspond to the respective printing dots interfere mutually. Consequently, in calculating the toner consumption amount of each printing dot, the distribution state of the dots which surround the dot subject to calculation is considered. More specifically, considering a (3 by 3)-dot matrix of which the center is the printing dot subject to calculation, the toner consumption amount is estimated in accordance with the number of the printing dots (referred to as “adjacent dots” hereinafter) other than the printing dot subject to calculation.

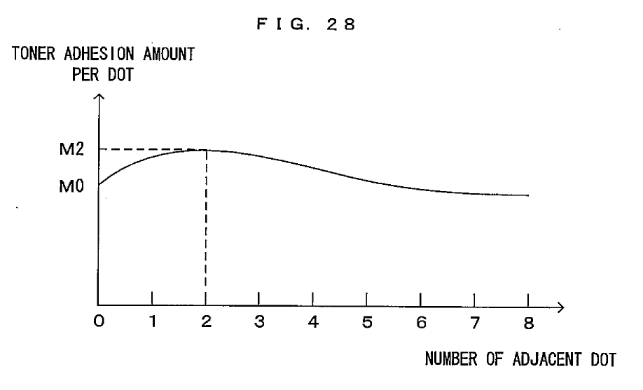

FIG. 28 is a graph showing the relationship between the number of the adjacent dots and the toner adhesion amount. As shown in FIG. 28, the toner amount which adheres to a single printing dot varies depending upon the number of the adjacent dots around it. In more detail, for example, in the case where the printing dot subject to calculation is an isolated dot around which there is no adjacent dot (corresponding to the case where the number of the adjacent dot is 0), the toner adhesion amount to the printing dot subject to calculation is M0. On the other hand, in the case where there are two other printing dots at a position adjacent to this printing dot (corresponding to the case where the number of the adjacent dot is 2), the toner adhesion amount to the printing dot is M2 and this value is a little larger than the value M0 which corresponds to the isolated dot. This is attributed to the fact that the wells of the electric potential which correspond to the printing dots which are formed at adjacent position on the photosensitive member 22 interfere mutually. And when the number of the adjacent dots increases further, the toner adhesion amount does not increase because the toner is split among the respective printing dots.

Based on this relationship, it is possible to calculate the toner consumption amount of each of the printing dots using a table which indicates the relationship between the number of the adjacent dots in the (3 by 3)-dot matrix of which the center is the printing dot subject to calculation and the toner adhesion amount. That is, a table is generated in advance in which the toner adhesion amount of the printing dot corresponds to the number of the adjacent dots. In calculating the toner consumption amount of a certain printing dot, the number of the adjacent dots of the printing dot subject to calculation is obtained, the table is referred based on the number, the number is converted to the toner consumption amount of the printing dot subject to calculation.

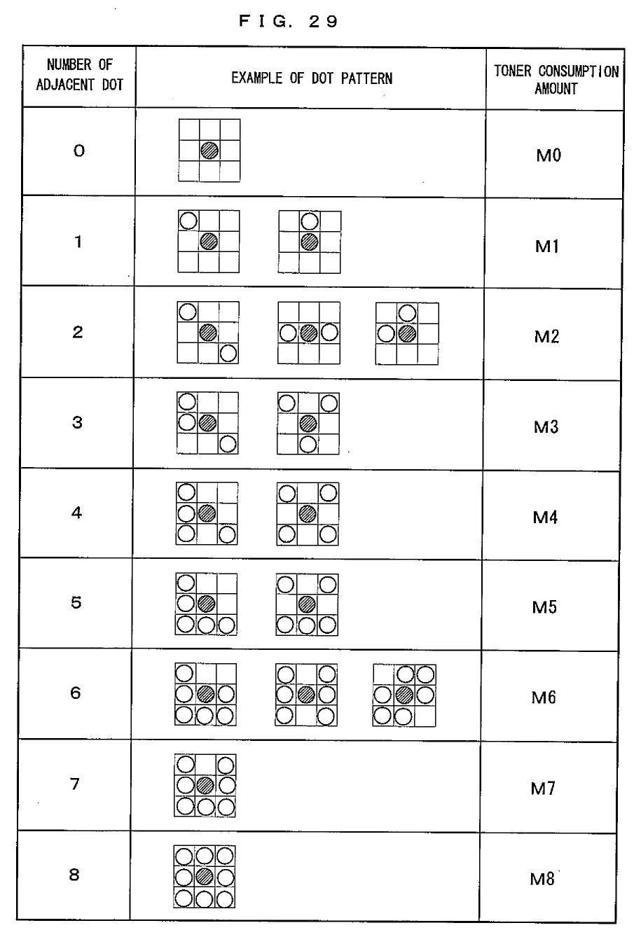

FIG. 29 is a drawing which shows an example of the conversion table from the number of the adjacent dots to the toner consumption amount. In the conversion table 263, the table is generated by making the connection between the number of the adjacent dots shown in FIG. 29 and the toner consumption amount. The pattern determination circuit 261 determines the number of the adjacent dots in the (3 by 3)-dot matrix of which the center is the printing dot subject to calculation based on the data stored in the data buffer 160 and outputs the number. The conversion table 263 outputs the toner consumption amount which corresponds to the number of the inputted adjacent dots. When the printing dot subject to calculation is the isolated dot for instance, the pattern determination circuit 261 outputs the value 0, and the conversion table 263 outputs the toner consumption amount M0 which corresponds to this value 0. This is repeatedly performed for one page, the outputs from the conversion table 263 are accumulated in the accumulator 265, whereby the value corresponding to the toner consumption amount of the toner image of one page remains in the accumulator 265.

(2) In the Case Where a Image is in Low Resolution (300 dpi) and Monochromatic;

In this case, since the printing dot is turned on and off in the (2 by 2)-dot unit, (2 by 2)-dot is defined as the unit segment for the calculation of the toner consumption amount. In this case, the calculation of the toner consumption amount may be performed by the calculation method (1) described above using a single unit segment to resemble a single hypothetical dot. However, the toner consumption amount may be calculated using easier way as described hereinafter. In the case of the image in low resolution, the printing dot is turned on and off in the (2 by 2)-dot unit as shown in FIG. 25. When the printing dot is considered one by one, there are always not less than three adjacent dots around each of the printing dots. As shown in FIG. 28, when the number of the adjacent dots is many, the change of the toner adhesion amount is little among the respective printing dots. Hence, in this case, it may be considered that (2 by 2) dots are one group of dots, and that the number of the groups is approximately in proportion to the toner consumption amount. That is, in the low resolution image; the number of the groups of dots in one page is counted, the number is multiplied by the toner adhesion amount per one group of dots, whereby the toner consumption amount of one page of toner image is calculated.

The pattern determination circuit 261 determines the state of the arrangement of the printing dots based on the data stored in the data buffer 160. And it outputs, for each unit segment, a value “1” when the unit segment is in the region to which toner should adhere, whereas a value “0” in the region to which toner should not adhere. The conversion table 263 outputs a value corresponding to the toner adhesion amount per one group of dots (2 by 2 dots) which is obtained in advance when the output from the pattern determination circuit 261 is “1”, whereas outputs a value 0 when the output from the pattern determination circuit 261 is “0”. When this is repeatedly performed for one page, the product of the number of groups of dots to adhere toner included in the 1-page toner image and the toner adhesion amount per one group of dots, that is, the value corresponding to the toner consumption amount for 1-page toner image is stored in the accumulator 265.

(3) In the Case Where a Image is in Color;

In the case where an image to be formed is a color image, the toner counter 260 sets the unit segment for each toner color individually, and calculates the toner consumption amount for each unit segment. And the results are added up for each toner color, whereby the toner consumption amount of one page of color image for each color individually. Specifically, the pattern determination circuit 261 in this case determines the arrangement pattern (dot pattern) of the printing dots in the segment for each unit segment which is set corresponding to the toner color, and outputs the result to the conversion table 263. For instance, (3 by 3)-dot is defined as the unit segment for magenta color, and a value corresponding to the dot pattern inside it is outputted.

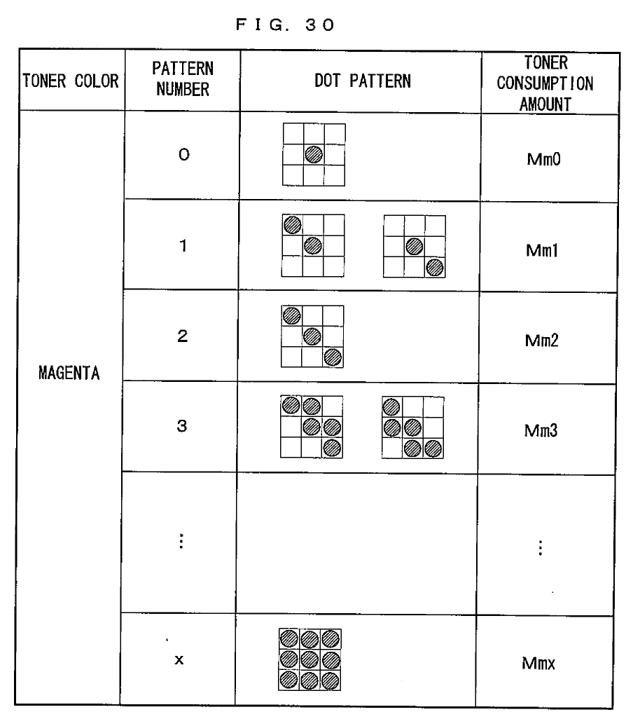

FIG. 30 is a drawing which shows a conversion table from the dot pattern to the toner adhesion amount. In the conversion table 763, as shown in FIG. 30, the table is generated by making the connection between the dot pattern in the (3 by 3)-dot matrix and the toner consumption amount. The pattern determination circuit 261 determines the dot pattern in each of the unit segment based on the data stored in the data buffer 160, and outputs a value corresponding to the pattern number. The conversion table 263, receiving this, outputs the toner consumption amount (any of Mm0 through Mmx) corresponding to the pattern number. When this is repeatedly performed for one page, the value corresponding to the toner consumption amount for one page of toner image is stored in the accumulator 265.

It is possible to calculate the toner consumption amount of the entire toner image for other color by setting the size of the unit segment which corresponds to the toner color, determining the dot pattern in each of the unit segments, and adding up the toner consumption amount corresponding to the dot pattern.

As described above, in the toner counter 260 in the image forming apparatus according to the invention, the toner image is divided into the unit segments of which the size is set in accordance with the content of the toner image, the toner consumption amount is obtained individually for each of the unit segments, and the results are added up, whereby the toner consumption amount of the entire toner image is obtained. In this way, the unit segment is set in accordance with the content of the toner image, whereby the toner consumption amount is calculated in a proper mode which corresponds to the appearing pattern of the printing dots. Hence, according to this embodiment, it is possible to calculate the toner consumption amount accurately and efficiently.

In addition, the toner consumption amount calculated in this way can be added to accumulate by the CPU 101 and be stored in the RAM 107 for instance for the management of the expendable supplies of the developers. For example, when the total toner consumption amount reaches a certain value, which means that the remaining amount of toner in the developer is less than a predetermined amount, a message indicating to user the fact that the remaining toner is little, a message prompting to user to change the developer, and the like may be displayed in the display 12.

As described above, in the above embodiment, the main controller 11 and the engine part EG function as a “signal processor” and an “image forming section” of the invention respectively. Especially, the photosensitive member 22 functions as a “latent image carrier” of the invention. Further, the video signal outputted from the main controller 11 corresponds to “printing-dot data” of the invention. Further, in this embodiment, the toner counter 260 functions as a “toner consumption amount calculator” of the invention. Further, in this embodiment, the area on the photosensitive member 22 which are represented by 1-dot matrix, (2 by 2)-dot matrix, (3 by 3)-dot matrix, (3 by 5)-dot matrix, and the like correspond to a “unit segment” of the invention. Further, in this embodiment, the data buffer 160 functions as a “storage” of the invention.

In addition, in the calculating method of the toner consumption amount which corresponds to the image in high resolution and monochromatic in the embodiment above, the toner consumption amount is obtained, each printing dot being defined as one unit segment. However, the toner consumption amount of each of the unit segments may be calculated, several dots being put together as one unit segment, corresponding to the arrangement of the printing dots inside the unit segment.

Further, in calculating the toner consumption amount of the image in high resolution and monochromatic in the embodiment described above, the toner consumption amount of each dot is obtained, the minimum dot being defined as the unit segment, corresponding to the number of the adjacent dots in the (3 by 3)-dot matrix. However, the method of calculating the toner consumption amount in the unit segment is not limited to this. This is because the invention has a feature in setting the size of the unit segment in accordance with the content of the data and calculating the toner consumption amount of each of the unit segments, and the invention does not limit the method of calculating the toner consumption amount of the unit segment.

Further, although the above embodiment is on the premise of not performing the screen processing in forming the monochromatic image, there are cases that the screen processing is performed even in forming the monochromatic image in this type of the image forming apparatus. In the apparatus of this kind, the technique to calculate the toner consumption amount of a color image described above, that is, the technique to calculate the toner consumption amount of the unit segment in accordance with the screen may be applied for a monochromatic image. This is true for an image forming apparatus exclusive for monochromatic image.

Further, there is a case that, if the application which generates the image data is known, the kind of image which the application can handle may be identified. In this case, the method of calculating the toner consumption amount may be changed in accordance with the kind of the application used. Further, in the apparatus structured to be able to determine the content of the image to be formed or the level of the image quality based on the setting by a user, the method of calculating the toner consumption amount may be changed in accordance with the content of the setting.

### FIFTH EMBODIMENT

In a toner counter of fifth and sixth embodiments described hereinafter, the technique (two-dimensional counting technique) to calculate the toner consumption amount considering the state of the two-dimensional arrangement of the printing dots and the technique (simple counting technique) to calculate the toner consumption amount of each of the printing dots without considering the state of the arrangement of the printing dots are selectively used.

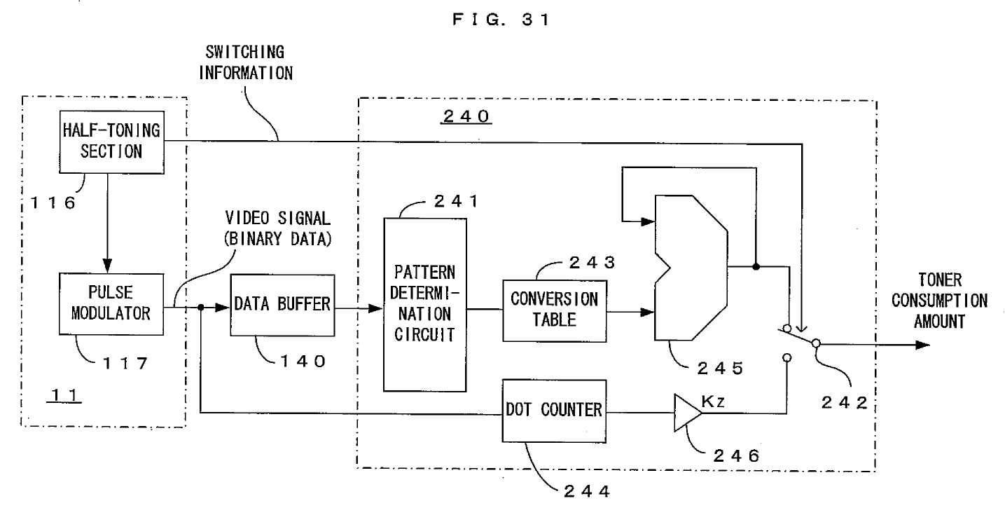

FIG. 31 is a diagram which shows a structure of a toner counter of the fifth embodiment. In this embodiment, a data buffer 140 which temporarily stores a video signal which is outputted from the pulse modulator 117 is provided in the engine controller 10. This video signal is binary data which indicate on and off states of the laser light which exposes the photosensitive member 22, that is, the state of the arrangement of the printing dots on the photosensitive member 22.

In a toner counter 240, a pattern determination circuit 241 is provided for determining the number of the adjacent dots of each of the printing dots based on the content of the data stored in the data buffer 140. More specifically, the pattern determination circuit 241 calculates and outputs the number of other printing dots which are present in the (3 by 3) matrix of which the center is the printing dot currently subject to calculation based on the data stored in the data buffer 140. This output is inputted into the conversion table 243 described above. A value corresponding to the toner consumption amount of the printing dot subject to calculation which is obtained in accordance with the number of the adjacent dots is outputted from the conversion table 243. This value is inputted into the accumulator 245 and is accumulated. Therefore, an accumulated value of the toner consumption amount of each of the printing dots which is obtained considering the state of the two-dimensional arrangement of the printing dots is kept in the accumulator 245.

On the other hand, in the toner counter 240, a dot counter 244 is further provided into which a video signal from the pulse modulator 117 is inputted. This dot counter 244 counts and outputs the number of the printing dots formed during a predetermined period of time based on the binary data which are included in the inputted video signal. In the case where the video signal is expressed with binary data of 1/0 for instance, the number of incidence of data 1 may be counted. A multiplier 246 is connected to the dot counter 244, and the output of the dot counter 244 is multiplied by a coefficient Kz which corresponds to the toner adhesion amount per one printing dot. Therefore, the output of the multiplier 246 is a product of the number of the formed printing dots and a certain toner adhesion ratio Kz, that is, the calculation result of the toner consumption amount which is obtained as a result of the simple counting technique.

An output of the accumulator 245 and an output of the multiplier 246 are respectively connected to a change switch 242. The change switch 242 is structured to switch contacts thereof based on the switching information given from the half-toning section 116. Hence, the toner counter 240, in effect, adopts either one of the two toner consumption amounts selected based on the switching information as the final toner consumption amount, one of the two toner consumption amounts being a value stored in the accumulator 245, that is, the toner consumption amount obtained by means of the two-dimensional counting technique, and the other of the two toner consumption amounts being a value outputted from the multiplier 246, that is, the toner consumption amount obtained by means of the simple counting technique.

In addition, the description is made here in such a way that the calculation of the toner consumption amount by means of the two-dimensional counting technique and the calculation of the toner consumption amount by means of the simple counting technique are handled concurrently. However, in an actual use, the calculation process of the one which the result is not adopted may be stopped. This is a great advantage when the toner counter 240 is realized with software. That is, the processing power of the CPU may be assigned to other functions.

Next, the switching information outputted from the half-toning section 116 is described. The switching information in this embodiment is information which indicates whether the signal given from the half-toning section 116 to the pulse modulator 117 has been performed the screen processing or not. More specifically, when the image to be formed is monochromatic and the content of which indicates that the screen processing is not required, the image may be estimated as an image mainly composed of a character and a line drawing and little with tone (such an image is called here a “line-based image”). In a case like this, the switching information is set to such a content that the switch 242 selects the output from the multiplier 246. On the other hand, when the image to be formed is a color image, or an image which requires the screen processing even in monochromatic, the image may be estimated as an image in which tone is heavily used (hereinafter called a “halftone image”). Consequently, the switching information in this case is set to such a content that the switch 242 selects the output from the accumulator 245.

As a result, the toner counter 240 adopts the toner consumption amount obtained by means of the simple counting technique of which the process is simple when the image to be formed is a monochromatic and a line-based image which the screen processing is not required. On the other hand, the toner counter 240 adopts the toner consumption amount obtained by means of the two-dimensional counting technique which can calculate the tone consumption amount accurately even for the image which contains much tone images when the image to be formed is a color image, or a halftone image which requires the screen processing even in monochromatic. In this way, one of the two kinds of counting technique is selectively used in accordance with the content of the image, whereby the toner consumption amount is obtained accurately and efficiently according to this embodiment.

### SIXTH EMBODIMENT

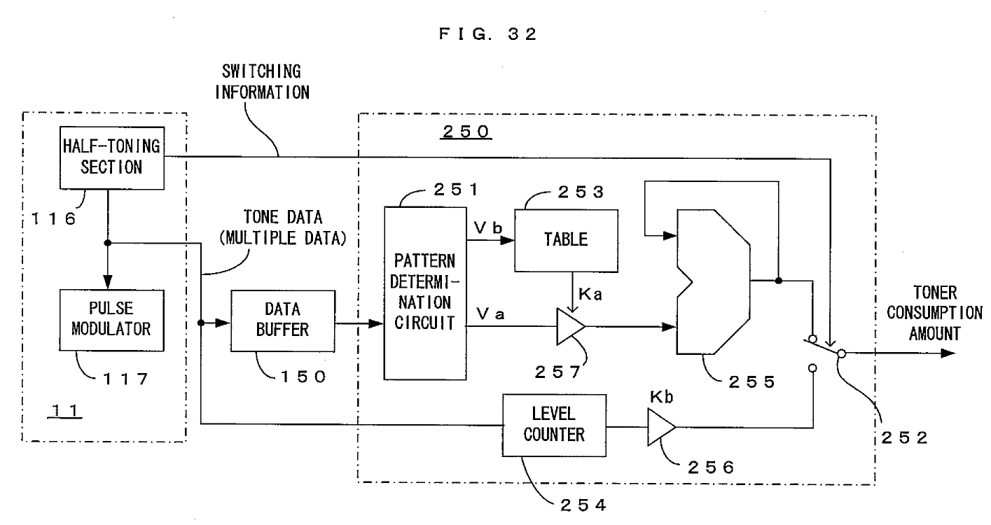

FIG. 32 is a diagram which shows a structure of a toner counter of the sixth embodiment. In this embodiment, the toner consumption amount is calculated based on the multiple tone data given from the half-toning section 116 to the pulse modulator 117, which is the most significant difference compared to the fifth embodiment described above. Further, the structure of the toner counter 250 is changed in association with this. More specifically, the toner consumption amount is calculated in this embodiment as follows.

In this embodiment, each of the printing dots is not expressed with binary data of simple on and off but with a multiple tone. Therefore, the toner consumption amount of one printing dot is not calculated based on the number of the adjacent dots of the printing dot subject to calculation but on the sum of the tone level of the printing dot subject to calculation and each of the tone levels of the adjacent dots of the printing dot subject to calculation. The description is made more specifically.

First, the calculation method by means of the two-dimensional counting technique is described. The multiple tone data outputted from the half-toning section 116 are temporarily stored in the data buffer 150. The pattern determination circuit 251 separately outputs a tone level Va of each of the printing dots and a value Vb which tone levels of other printing dots (maximum number is 8) which are present in the 3 by 3 matrix of which the center is the printing dot subject to calculation are accumulated.

Considering the printing dot currently subject to calculation, it is easily understood that the amount of toner consumed in forming the printing dot subject to calculation is affected not only by the tone level Va of the printing dot subject to calculation but also the tone levels of the adjacent dots formed around it. Therefore, in this embodiment, the tone level Va of the printing dot subject to calculation is multiplied by a coefficient Ka which is obtained in accordance with the value Vb which is the sum of the tone levels of the adjacent dots thereof, whereby the toner consumption amount of the printing dot subject to calculation is calculated.

Specifically, the table 253 is referred to based on the value of the sum Vb of the tone levels of the adjacent dots outputted from the pattern determination circuit 251, and the coefficient Ka corresponding to the state of the adjacent dots is determined. This coefficient Ka is multiplied by the tone level Va of the printing dot subject to calculation which is outputted from the pattern determination circuit 251 by means of the multiplier 257. The output of the multiplier 257 indicates the toner consumption amount of the printing dot subject to calculation. In other words, the coefficient Ka is a value weighted considering the state of the adjacent dot to the toner adhesion rate per one tone level. This value is accumulated in the accumulator 255, whereby the total toner consumption amount is calculated.

Next, the calculation method by means of the simple counting technique is described. In this embodiment, the multiple tone data outputted from the half-toning section 116 are also inputted into a level counter 254. This level counter 254 counts and accumulates not the number of the printing dots but the tone levels of each of the printing dots. Then, the accumulated value is multiplied by a constant coefficient Kb which corresponds to the toner adhesion rate per one tone level by means of the multiplier 256, whereby the toner consumption amount by means of the simple counting technique is calculated. And either one of the output of the accumulator 255 and the output of the multiplier 256 is selected by the switch 252. It is the same as the fifth embodiment on this point.

As described above, both in the fifth and sixth embodiments of the toner counter in the image forming apparatus according to the invention, it is possible to calculate the toner consumption amount in two modes, one being the two-dimensional counting technique which calculates the toner consumption amount of each of the printing dots based on the state of the two-dimensional arrangement of the printing dots, the other being the simple counting technique which calculates the toner consumption amount of each of the printing dots without considering the arrangement of the dots. And these two modes are selectively used in accordance with the content of the images, whereby the toner consumption amount in the image forming apparatus is calculated accurately and efficiently according to these embodiments.

In addition, the toner consumption amount calculated in this way can be added to accumulate by the CPU 101 and be stored in the RAM 107 for instance for the management of the expendable supplies of the developers. For example, when the total toner consumption amount reaches a certain value, which means that the remaining amount of toner in the developer is less than a predetermined amount, a message indicating to user the fact that the remaining toner is little, a message prompting to user to change the developer, and the like may be displayed in the display 12.

Further, there are cases that a part of toner stored in the developers is consumed as the so-called fogging or scatters into the inside of the apparatus from the developing roller 44, without contributing to the formation of the toner image. Since the amount of toner like this cannot be obtained by the method described above, the amount of toner like this is estimated by means of other proper method, the estimation is added to the toner consumption amount obtained by the toner counter 230 described above, whereby the remaining toner amount in the developer is calculated more accurately.

As described above, in these embodiments, the main controller 11 and the engine part EG function as a “signal processor” and an “image forming section” of the invention respectively. Especially, the photosensitive member 22 functions as a “latent image carrier” of the invention. Further, the video signal (fifth embodiment) or the tone data (sixth embodiment) outputted from the main controller 11 corresponds to “printing-dot data” of the invention. Further, in these embodiments, the toner counters 240 and 250 function as a “toner consumption amount calculator” of the invention. Further, in these embodiments, the area on the photosensitive member 22 which is represented by the (3 by 3) matrix corresponds to a “surface area subject to calculating process” of the invention. Further, in these embodiments, the data buffers 140 and 150 function as a “storage” of the invention.

In addition, in the two-dimensional counting technique in the embodiments above, in accordance with the distribution state of the adjacent dots in the 3 by 3-dot matrix, the toner consumption amount of the printing dot which is the center thereof is calculated. However, in the two-dimensional counting technique, the extent of the area around the printing dot subject to calculation to take into consideration is chosen arbitrarily. In the embodiments above also, the adjacent dots in the matrix of 3 dots by 5 dots or 5 dots by 5 dots for instance may be considered.

Further, the two-dimensional counting technique may be made executable in a plurality of modes in which the size of the matrix is different from each other, and when the two-dimensional counting technique is applied, one of the modes may be selected and applied. For example, in the case where the screen applied is different for each toner color, different mode of the two-dimensional counting technique may be adopted for each screen, or for each toner color.

Further, there is a case that, if the application which generates the image data is known, the kind of image which the application can handle may be identified. In this case, the method of calculating the toner consumption amount may be changed in accordance with the kind of the application used. Further, in the apparatus structured to be able to determine the content of the image to be formed or the level of the image quality based of the setting by a user, the method of calculating the toner consumption amount may be changed in accordance with the content of the setting.

### INDUSTRIAL APPLICABILITY

The invention may be applied to other image forming apparatus such as an apparatus which comprises only a developer in accordance with a black color toner for instance and which forms monochromatic image, an apparatus which comprises a transfer medium (such as transfer drum, transfer sheet, and the like) other than the intermediate transfer belt, and a copier machine, a facsimile machine, and the like other than the color image forming apparatus described above.

1. An image forming apparatus, comprising:
a latent image carrier which is able to carry an electrostatic latent image on a surface thereof;
a developing section which visualizes the electrostatic latent image on the surface of the latent image carrier with toner and forms a toner image; and
a toner consumption amount calculator which calculates a toner consumption amount consumed by the developing section, wherein
the toner consumption amount calculator calculates the toner consumption amount based on a state of a two-dimensional arrangement of a plurality of printing dots formed on the latent image carrier.

2. The image forming apparatus of claim 1, further comprising:
a latent image forming section which forms a plurality of linear latent images on the latent image carrier of which the positions are different from each other, thereby forming a two-dimensional electrostatic latent image on the surface of the latent image carrier; and
a storage which stores image data which correspond to a plurality of lines of the plurality of linear latent images, wherein
the toner consumption amount calculator determines the state of the two-dimensional arrangement of the plurality of printing dots based on the image data stored in the storage.

3. The image forming apparatus of claim 1, wherein
the toner consumption amount calculator calculates a toner consumption amount of each of the plurality of printing dots formed on the latent image carrier based on the number of printing dots formed in a predetermined area surrounding the printing dot subject to calculation in the surface of the latent image carrier.

4. The image forming apparatus of claim 3, wherein
the toner consumption amount calculator accumulates the toner consumption amount of each of the plurality of printing dots formed during a period of time subject to calculation, thereby calculating a total toner consumption amount during the period of time.

5. The image forming apparatus of claim 1, wherein
the toner consumption amount calculator divides the plurality of printing dots formed on the latent image carrier into classes depending upon the number of printing dots formed in a predetermined area surrounding the printing dot subject to calculation in the surface of the latent image carrier, counts the number of printing dots classified to the respective classes, multiplies each of the counted numbers of the respective classes by each of weighted coefficients which are predetermined for the respective classes, and accumulates the products of the multiplication, thereby calculating the toner consumption amount.

6. An image forming apparatus, comprising:
an image forming section which visualizes an electrostatic latent image with toner and forms a toner image; and
a toner consumption amount calculator which calculates a toner consumption amount consumed in forming the toner image, wherein
the toner consumption amount calculator varies a mode of a calculation of the toner consumption amount depending upon a distribution state of printing dots to which toner should adhere in the toner image.

7. The image forming apparatus of claim 6, wherein
the toner consumption amount calculator determines the mode of the calculation of the toner consumption amount depending upon a size of a distance between the printing dots in the toner image.

8. The image forming apparatus of claim 6, further comprising a signal processor which executes a predetermined signal processing to an image signal and generates a control signal for the image forming section, wherein
the toner consumption amount calculator estimates the distribution state of the printing dots based on a content of the signal processing executed by the signal processor, and determines the mode of the calculation of the toner consumption amount based on the estimation result.

9. The image forming apparatus of claim 8, wherein
the signal processor is structured to be able to execute a screen processing as the signal processing, the screen processing being a processing to select a screen which corresponds to the image signal from among a plurality of kinds of screens prepared in advance, and to process the image signal using the selected screen, and
the toner consumption amount calculator determines the mode of the calculation of the toner consumption amount depending upon the selected screen.

10. The image forming apparatus of claim 9, wherein
in the case where a toner image, which is formed during a predetermined period of time subject to calculation, includes a plurality of areas in which screens different from each other are used, the toner consumption amount calculator calculates the toner consumption amount during the period of time in each of the plurality of areas in the mode corresponding to the used screen.

11. The image forming apparatus of claim 6, wherein the toner consumption amount calculator comprises:
a counter which counts the number of a printing-dot group composed of not less than one printing dot arranged in succession or the number of printing dots which compose the printing-dot group; and
a calculating section which calculates the toner consumption amount based on the counted value of the counter.

12. The image forming apparatus of claim 11, wherein
the calculating section multiplies the counted value of the counter by a predetermined coefficient which is set depending upon a distribution state of the printing-dot group, thereby calculating the toner consumption amount.

13. An image forming apparatus, comprising:
a signal processor which executes a predetermined signal processing to an image signal and generates a printing-dot data regarding an arrangement of printing dots;
an image forming section which forms an electrostatic latent image on a latent image carrier corresponding to the printing dots, and visualizes the electrostatic latent image with toner, thereby forming a toner image which corresponds to the image signal; and
a toner consumption amount calculator which calculates a toner amount consumed in forming the toner image based on the printing-dot data and a state of a two-dimensional arrangement of the printing dots in the electrostatic latent image, wherein
the toner consumption amount calculator varies a mode of a calculation of the consumed toner amount depending upon a content of the printing-dot data.

14. The image forming apparatus of claim 13, wherein
the toner consumption amount calculator calculates a toner amount consumed in forming each of the printing dots on the latent image carrier, based on a distribution state of the printing dots in a surface area subject to calculating process which is composed of the printing dot subject to calculation and an adjacent area thereof in a surface of the latent image carrier, and accumulates the toner amount of each of the printing dots, thereby calculating a toner consumption amount of the entire toner image, and wherein
the toner consumption amount calculator varies a size of the surface area subject to calculating process depending upon the content of the printing-dot data.

15. The image forming apparatus of claim 14, wherein
the printing-dot data are generated in the signal processing which includes a screen processing and which is executed by the signal processor, and
the toner consumption amount calculator sets the size of the surface area subject to calculating process depending upon a kind of a screen which is used in generating the printing-dot data in the signal processor.

16. The image forming apparatus of claim 14, wherein
the toner consumption amount calculator sets the size of the surface area subject to calculating process larger in the case where the printing-dot data are generated by the signal processor in the signal processing which includes a screen processing, than in the case where the printing-dot data are generated in the signal processing which does not include the screen processing.

17. The image forming apparatus of claim 14, wherein
the image forming section is structured to be able to form selectively a monochromatic image with toner of a single color and a color image with a plurality of kinds of toner of which the colors are different from each other, and
the toner consumption amount calculator sets the size of the surface area subject to calculating process larger in the case where the printing-dot data correspond to the color image, than in the case where the printing-dot data correspond to the monochromatic image.

18. The image forming apparatus of claim 13, further comprising a storage which stores the printing-dot data temporarily, wherein
the toner consumption amount calculator determines the content of the printing-dot data based on the printing-dot data stored in the storage.

19. The image forming apparatus of claim 13, wherein
the signal processor generates the printing-dot data composed of tone data expressed with multiple data, whereas
the toner consumption amount calculator calculates a frequency of appearance of a printing dot which has a particular tone value based on the printing-dot data, and determines the content of the printing-dot data based on the calculated frequency.

20. The image forming apparatus of claim 13, wherein
the signal processor gives information regarding the content of the printing-dot data to the toner consumption amount calculator.

21. An image forming apparatus, comprising:
a signal processor which executes a predetermined signal processing to an image signal and generates a printing-dot data regarding an arrangement of printing dots;
an image forming section which forms an electrostatic latent image on a latent image carrier corresponding to the printing dots, and visualizes the electrostatic latent image with toner, thereby forming a toner image which corresponds to the image signal; and
a toner consumption amount calculator which calculates a toner amount consumed in forming the toner image, wherein
the toner consumption amount calculator divides the toner image into a plurality of unit segments having a predetermined size, calculates a toner consumption amount of each of the plurality of unit segments based on the printing-dot data, and accumulates the toner consumption amount of each of the plurality of unit segments, thereby calculating a toner consumption amount of the entire toner image, and wherein
the toner consumption amount calculator varies the settings of the size of the unit segment depending upon a content of the printing-dot data.

22. The image forming apparatus of claim 21, wherein
the toner consumption amount calculator sets the size of the unit segment depending upon a resolution of the toner image corresponding to the printing-dot data.

23. The image forming apparatus of claim 22, wherein
the toner consumption amount calculator sets the size of the unit segment smaller as the resolution becomes higher.

24. The image forming apparatus of claim 21, wherein
the toner consumption amount calculator sets the size of the unit segment depending upon a kind of a screen which is used in generating the printing-dot data in the signal processor.

25. The image forming apparatus of claim 21, wherein
the toner consumption amount calculator sets the size of the unit segment smaller in the case where the printing-dot data are generated by the signal processor in the signal processing which includes a screen processing, than in the case where the printing-dot data are generated in the signal processing which does not include the screen processing.

26. The image forming apparatus of claim 21, wherein
the image forming section is structured to be able to form selectively a monochromatic image with toner of a single color and a color image with a plurality of kinds of toner of which the colors are different from each other, and
the toner consumption amount calculator sets the size of the unit segment smaller in the case where the printing-dot data correspond to the color image, than in the case where the printing-dot data correspond to the monochromatic image.

27. The image forming apparatus of claim 21, further comprising a storage which stores the printing-dot data temporarily, wherein
the toner consumption amount calculator determines the content of the printing-dot data based on the printing-dot data stored in the storage.

28. The image forming apparatus of claim 21, wherein
the signal processor generates the printing-dot data composed of tone data expressed with multiple data, whereas
the toner consumption amount calculator calculates a frequency of appearance of a printing dot which has a particular tone value based on the printing-dot data, and determines the content of the printing-dot data based on the calculated frequency.

29. The image forming apparatus of claim 21, wherein
the signal processor gives information regarding the content of the printing-dot data to the toner consumption amount calculator.

30. The image forming apparatus of claim 21, wherein
the toner consumption amount calculator calculates a toner consumption amount of one of the unit segments based on the printing-dot data which correspond to the unit segment subject to calculation and the printing-dot data which correspond to the unit segment adjacent to the unit segment subject to calculation.

31. An image forming apparatus, comprising:
a signal processor which executes a predetermined signal processing to an image signal and generates printing-dot data regarding an arrangement of printing dots;
an image forming section which forms an electrostatic latent image on a latent image carrier corresponding to the printing dots, and visualizes the electrostatic latent image with toner, thereby forming a toner image which corresponds to the image signal; and
a toner consumption amount calculator which accumulates a toner consumption amount consumed in forming each of the printing dots on the latent image carrier, thereby calculating a toner consumption amount consumed in forming the toner image, wherein
the toner consumption amount calculator is able to execute a simple count mode and a two-dimensional count mode, the simple count mode calculating the toner consumption amount of each of the printing dots based on the printing-dot data corresponding to the printing dot subject to calculation, the two-dimensional count mode calculating the toner consumption amount of each of the printing dots based on a state of a two-dimensional arrangement of the printing dots on the latent image carrier, and wherein
the toner consumption amount calculator selectively executes either one of the modes depending upon a content of the printing-dot data.

32. The image forming apparatus of claim 31, wherein
the toner consumption amount calculator calculates, in the two-dimensional count mode, the toner consumption amount of each of the printing dots based on a state of a distribution of the printing dots in a surface area subject to calculating process which is composed of the printing dot subject to calculation and an adjacent area thereof in a surface of the latent image carrier.

33. The image forming apparatus of claim 31, wherein
the toner consumption amount calculator selects the two-dimensional count mode in the case where the printing-dot data are generated by the signal processor in the signal processing which includes a screen processing, whereas selects the simple count mode in the case where the printing-dot data are generated in the signal processing which does not include the screen processing.

34. The image forming apparatus of claim 31, wherein
the image forming section is structured to be able to form selectively a monochromatic image with toner of a single color and a color image with a plurality of kinds of toner of which the colors are different from each other, and
the toner consumption amount calculator selects the two-dimensional count mode in the case where the printing-dot data correspond to the color image, whereas selects the simple count mode in the case where the printing-dot data correspond to the monochromatic image.

35. The image forming apparatus of claim 31, wherein
the toner consumption amount calculator selects the two-dimensional count mode in the case where the printing-dot data correspond to a graphic image, whereas selects the simple count mode in the case where the printing-dot data correspond to a character image.

36. The image forming apparatus of claim 31, further comprising a storage which stores the printing-dot data temporarily, wherein
the toner consumption amount calculator determines the content of the printing-dot data based on the printing-dot data stored in the storage.

37. The image forming apparatus of claim 31, wherein
the signal processor generates the printing-dot data composed of tone data expressed with multiple data, whereas
the toner consumption amount calculator calculates a frequency of appearance of a printing dot which has a particular tone value based on the printing-dot data, and determines the content of the printing-dot data based on the calculated frequency.

38. The image forming apparatus of claim 31, wherein
the signal processor gives information regarding the content of the printing-dot data to the toner consumption amount calculator.

39. A toner counter which is used in an image forming apparatus which visualizes an electrostatic latent image on a surface of a latent image carrier with toner and forms a toner image, the toner counter comprising:
a determining section which determines a state of a two-dimensional arrangement of a plurality of printing dots formed on the latent image carrier; and
a calculating section which calculates a toner consumption amount based on the determination result by the determining section.

40. The toner counter of claim 39, wherein
the determining section divides the plurality of printing dots formed on the latent image carrier into classes depending upon the number of printing dots formed in a predetermined area surrounding the printing dot subject to calculation in the surface of the latent image carrier, and
the calculating section counts the number of printing dots classified to the respective classes, multiplies each of the counted numbers of the respective classes by each of weighted coefficients which are predetermined for the respective classes, and accumulates the products of the multiplication, thereby calculating the toner consumption amount.

41. A toner counter which is used in an image forming apparatus which visualizes an electrostatic latent image with toner and forms a toner image and which calculates a toner consumption amount consumed in forming the toner image, the toner counter comprising:
a setting section which sets a mode of calculating the toner consumption amount depending upon a distribution state of printing dots to which toner should adhere in the toner image; and
a calculating section which calculates the toner consumption amount in the mode set by the setting section.

42. A toner counter which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the toner counter comprising:
a determining section which determines a state of a two-dimensional arrangement of the printing dots in the electrostatic latent image and sets a mode of calculating the toner consumption amount based on the determination result; and
a calculating section which calculates the toner consumption amount in the mode set by the setting section.

43. A toner counter which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the toner counter comprising:
a calculating section which divides the toner image into a plurality of unit segments having a predetermined size, calculates a toner consumption amount of each of the plurality of unit segments based on the printing-dot data, and accumulates the toner consumption amount of each of the plurality of unit segments, thereby calculating a toner consumption amount of the entire toner image; and
a setting section which varies the settings of the size of the unit segment depending upon a content of the printing-dot data.

44. A toner counter which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the toner counter comprising:
a counting section which is able to execute a simple count mode and a two-dimensional count mode, the simple count mode calculating the toner consumption amount of each of the printing dots based on the printing-dot data corresponding to the printing dot subject to calculation, the two-dimensional count mode calculating the toner consumption amount of each of the printing dots based on a state of a two-dimensional arrangement of the printing dots on the latent image carrier; and
a selecting section which selects either one of the modes depending upon a content of the printing-dot data and make the counting section execute the selected mode.

45. A method of calculating toner consumption amount in an image forming apparatus which visualizes an electrostatic latent image on a surface of a latent image carrier with toner and forms a toner image, the method comprising the steps of:
determining a state of a two-dimensional arrangement of printing dots formed on the latent image carrier; and
calculating a toner consumption amount based on the determination result.

46. A method of calculating toner consumption amount, in an image forming apparatus which visualizes an electrostatic latent image with toner and forms a toner image, which calculates a toner consumption amount consumed in forming the toner image, the method comprising the steps of:
setting a mode of calculating the toner consumption amount depending upon a distribution state of printing dots to which toner should adhere in the toner image; and
calculating the toner consumption amount in the set mode.

47. A method of calculating toner consumption amount which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the method comprising the steps of:
setting a mode of calculating the toner consumption amount based on the printing-dot data and a state of a two-dimensional arrangement of the printing dots in the electrostatic latent image; and
calculating the toner consumption amount in the set mode.

48. A method of calculating toner consumption amount which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the method comprising the steps of:
dividing the toner image into a plurality of unit segments of which the size is set depending upon a content of the printing-dot data;
calculating a toner consumption amount of each of the plurality of unit segments based on the printing-dot data; and
accumulating the toner consumption amount of each of the plurality of unit segments, thereby calculating a toner consumption amount of the entire toner image.

49. A method of calculating toner consumption amount which calculates a toner consumption amount in an image forming apparatus which executes a predetermined signal processing to an image signal to generate a printing-dot data regarding an arrangement of printing dots, forms an electrostatic latent image on a latent image carrier corresponding to the printing dots and visualizes the electrostatic latent image with toner, thereby forming a toner image which corresponds to the image signal, the method comprising the steps of:
selecting either one of a simple count mode and a two-dimensional count mode depending upon a content of the printing-dot data, the simple count mode calculating the toner consumption amount of each of the printing dots based on the printing-dot data corresponding to the printing dot subject to calculation, the two-dimensional count mode calculating the toner consumption amount of each of the printing dots based on a state of a two-dimensional arrangement of the printing dots on the latent image carrier; and
calculating the toner consumption amount consumed in forming the toner image in the selected mode.
